(19) United States
(12) Patent Application Publication
(10) Pub. No.: US 2015/0371009 A1
(43) Pub. Date: Dec. 24, 2015

(54) DRUG IDENTIFICATION MODELS AND METHODS OF USING THE SAME TO IDENTIFY COMPOUNDS TO TREAT DISEASE

(71) Applicant: Jake Yue Chen, Indianapolis, IN (US)

(72) Inventor: Jake Yue Chen, Indianapolis, IN (US)

(21) Appl. No.: 14/745,298

(22) Filed: Jun. 19, 2015

Related U.S. Application Data
(60) Provisional application No. 62/014,363, filed on Jun. 19, 2014.

(51) Int. Cl. G06F 19/00; G06F 19/24

(52) U.S. Cl. CPC G06F 19/706; G06F 19/24

(57) ABSTRACT

Drug identification models and methods of using the same to identify compounds to treat disease. In at least one method of the present disclosure, at least one first drug/compound which is not actively approved by a governmental regulatory entity to treat a targeted disease or condition, which was not previously approved to treat the targeted disease or condition, and which was not previously withdrawn from clinical testing in connection with the targeted disease or condition is tested within a framework configured using drug/compound data from actively approved drugs/compounds and withdrawn drugs/compounds in attempt to identify at least one candidate drug/compound to treat the targeted disease or condition.

### PRIORITY

The present U.S. nonprovisional patent application is related to, claims the priority benefit of, U.S. provisional patent application Ser. No. 62/014,363 filed Jun. 19, 2014, the contents of which are hereby incorporated by reference in their entirety into this disclosure.

### BACKGROUND

The emergence of drug repurposing not only reduces drug development costs but also shortens the development cycle significantly. Therefore drug repurpo sing allows academic settings and small pharmaceutical companies to play a more active role in the drug discovery arena, especially with recent computational power. From computational points of view, recent techniques for drug repurposing could be divided into three categories: mining electronic health records, association-based approaches (or “guilt-by-association” approaches), and phenotypic matching approaches.

First, the mining electronic health record approach takes the advantage of the massive clinical and electrical health records to detect the potential therapeutic effects and side effects from one drug treatment, and then links these effects to other diseases to suggest new potential clinical trials. In addition, data mining and text mining are able to discover significant information to construct and extend the knowledge bases to be applied in drug repurposing. However, data mining techniques for drug repurposing are still in the beginning phase and their innovation could be expected in the near future.

Second, the “guilt-by-association” techniques attempts to construct mathematical drug-drug similarities and disease-disease similarities to suggest new therapeutic drug-disease treatments from well-known drug-disease treatments. Methods to construct drug-similarities are expression profile based, side-effect based chemical structure based and gene ontology (GO) based. Several methods to construct disease similarity profiles are phenotype based, GO based, expression profile based, and protein interaction network (PPI) based. After determining drug and diseases similarities, different strategies combine these associations to assign the repurposing scores for the drug-disease candidate pair, such as weighted geometric mean, statistical measurement, network motif discovery (or clustering) and labeling by neighborhood. The “guilt-by-association” techniques have the advantages of processing large drug, disease and molecular databases. Thus, “guilt-by-association” is able to suggest a large number of repurposing candidates. In addition, clustering drugs based on similarity measurements may reveal important drug mechanisms and motifs. On the other hand, since “guilt-by-association” techniques do not apply disease pathway models, discovered mechanisms and motifs are likely close to the drugs' target instead of exploring deeper molecular interactions in the disease pathway model. In addition, these techniques either do not rank the repurposing candidates, or the ranking mechanism does not apply the clinical trial data.

Third, the pattern matching approaches focus on the disease specific patterns such as prioritized proteins, differentially expressed proteins, and ranked drug therapy by counting how many patterns the drug can hit. This is normally done at the physiological phenotype level, e.g., observed phenotypic modification effects (including both unanticipated therapeutic effects and side effects). The most well-known technique in this category is Connectivity Map (CMap). Lamb et al propose the fundamental assumption about the opposite matching between the drug and the disease protein patterns. Later drug connectivity maps inherit this fundamental assumption and extend the database of drug and disease patterns at the cell-molecule level and phenotype level. On the other hand, directly implement Lamb's assumption by combining CMap data with GEO expression data to compute the pattern matching between drugs and diseases. In a different approach without CMap, proposes drug repurposing based on statistical computational matching at disease specific pathway model. Among 3 categories, pattern matching techniques are the most straightforward, performing repurposing at the genetic level and ranking repurposing candidates. Despite the great success, the main disadvantage of pattern matching techniques is the cost of obtaining large drug genomic profiles because this data is obtained via expensive biological experiment, rendering ranking resolution limited. Each of the foregoing have disadvantages as noted above.

Research and development efforts in connection with the identification of compounds for use to treat various diseases and disorders are typically in the cumulative order of hundreds of millions to billions of dollars per year. In view of the same, a research model useful to test a variety of compounds against compounds known to treat a certain disease or disorder, would be well received in the medical arts. In addition, the identification of compounds or classes of compounds to treat breast cancer would also be well received.

### BRIEF SUMMARY

The present disclosure includes disclosure of a method of treating breast cancer using donepezil, donepezil hydrochloride, or a variant thereof.

The present disclosure also includes disclosure of donepezil, donepezil hydrochloride, or a variant thereof for the treatment of breast cancer.

In at least one embodiment of a system of the present disclosure, the system is useful to analyze one or more drugs to determine whether one or more of the one or more drugs are potential drugs useful to treat breast cancer.

In at least one embodiment of a system of the present disclosure, the system is useful to analyze one or more drugs to determine whether one or more of the one or more drugs are potential drugs useful to treat an identified disease or disorder.

The present disclosure also includes disclosure of a compound effective to treat breast cancer, comprising donepezil, donepezil hydrochloride, or a variant thereof.

In at least one embodiment of a method of the present disclosure, the method comprises the steps of identifying a group of compounds to test within an integrated pathway model, testing the group of compounds within the integrated pathway model along with at least one compound with a known effectiveness to treat a disease or disorder to obtain data, and analyzing the data to determine if any compound within the group of compounds has one or more scores similar to a score of the at least one compound.

In at least one embodiment of a method of the present disclosure, the method comprises the steps of selecting at least one first drug/compound which is not actively approved by a governmental regulatory entity to treat a targeted disease or condition, which was not previously approved to treat the targeted disease or condition, and which was not previously withdrawn from clinical testing in connection with the targeted disease or condition, testing using a framework the at least one first drug/compound to obtain first drug/compound data, wherein the framework is configured based upon at least a) second drug/compound data from within the framework, the second drug/compound data obtained from at least one second drug/compound which is actively approved to treat a targeted disease or condition, b) third drug/compound data from within the framework, the third drug/compound data obtained from at least one third drug/compound which selected from the group consisting of a drug/compound previously approved to treat the targeted disease or condition and a drug/compound previously withdrawn from clinical testing in connection with the targeted disease or condition, and c) integrated drug-to-target information, drug-to-gene information, and protein-to-protein information each relevant to the targeted disease or condition, and comparing the first drug/compound data to the second drug/compound data and the third drug/compound data to determine if the first drug/compound data and/or the third drug/compound data identifies a candidate drug/compound to treat the targeted disease or condition. In at least one embodiment, the step of comparing comprises the step of ranking the first drug/compound data, the second drug/compound data, and the third drug/compound data in an order from most positive to least positive, wherein the most positive is indicative of a drug/compound likely to be the most effective to treat the targeted disease or condition. In at least one embodiment, the step of testing comprises testing using the framework comprising a drug-molecular indication database. In at least one embodiment, the at least one first drug/compound comprises at least one drug/compound under clinical testing to treat the targeted disease or condition. In at least one embodiment, the at least one first drug/compound comprises at least one drug/compound under pre-clinical testing to treat the targeted disease or condition. In at least one embodiment, the at least one first drug/compound comprises at least one drug/compound previously approved to treat a disease or condition that is not the targeted disease or condition. In at least one embodiment, the at least one first drug/compound comprises at least one drug/compound withdrawn from clinical testing in connection with a targeted disease or condition that is not the targeted disease or condition. In at least one embodiment, the at least one third drug/compound is not approved to treat the targeted disease or condition for safety or efficacy reasons. In at least one embodiment, the framework comprises a processor operably coupled to a storage medium, the storage medium having software stored therein configured for use by the processor to perform the testing step and the comparing step. In at least one embodiment, the method further comprises the step of administering a dose of one of the at least one candidate drug/compound to a patient having the targeted disease or condition to treat the patient. In at least one embodiment, at least one of the at least one first drug/compound has at least one chemical structure similar to at least one of the at least one second drug/compound. In at least one embodiment, at least one of the at least one first drug/compound and at least one of the at least one second drug/compound targeted a common disease risk gene. In at least one embodiment, the step of ranking is performed to rank based upon inferred mechanisms of action. In at least one embodiment, the step of ranking is performed to rank based upon subsequent cell line or patient-derived samples. In at least one embodiment, the at least one first drug/compound comprises donepezil, donepezil hydrochloride, or a variant thereof, wherein the targeted disease or condition comprises breast cancer, and wherein the first drug/compound data identifies that at least one of donepezil, donepezil hydrochloride, or a variant thereof, as the candidate drug/compound to treat breast cancer. In at least one embodiment, the method further comprises the step of administering a dose of the at least one of donepezil, donepezil hydrochloride, or a variant thereof, to a patient having breast cancer to treat the patient. In at least one embodiment, at least one candidate drug/compound to treat the targeted disease or condition is identified from performing the comparing step.

The present disclosure includes disclosure of a framework comprising a computer system having a processor operably coupled to a storage medium, whereby the storage medium has software stored thereon configured to be used by the processor to perform a computer implemented method, the computer-implemented method comprising the steps of selecting at least one first drug/compound which is not actively approved by a governmental regulatory entity to treat a targeted disease or condition, which was not previously approved to treat the targeted disease or condition, and which was not previously withdrawn from clinical testing in connection with the targeted disease or condition, testing using a framework the at least one first drug/compound to obtain first drug/compound data, wherein the framework is configured based upon at least a) second drug/compound data from within the framework, the second drug/compound data obtained from at least one second drug/compound which is actively approved to treat a targeted disease or condition, b) third drug/compound data from within the framework, the third drug/compound data obtained from at least one third drug/compound which selected from the group consisting of a drug/compound previously approved to treat the targeted disease or condition and a drug/compound previously withdrawn from clinical testing in connection with the targeted disease or condition, and c) integrated drug-to-target information, drug-to-gene information, and protein-to-protein information each relevant to the targeted disease or condition, and comparing the first drug/compound data to the second drug/compound data and the third drug/compound data to determine if the first drug/compound data and/or the third drug/compound data identifies a candidate drug/compound to treat the targeted disease or condition. In at least one embodiment, the step of comparing comprises the step of ranking the first drug/compound data, the second drug/compound data, and the third drug/compound data in an order from most positive to least positive, wherein the most positive is indicative of a drug/compound likely to be the most effective to treat the targeted disease or condition.

In at least one embodiment of a method of the present disclosure, the method comprises the steps of selecting at least one first drug/compound which is not actively approved by a governmental regulatory entity to treat a targeted disease or condition, which was not previously approved to treat the targeted disease or condition, and which was not previously withdrawn from clinical testing in connection with the targeted disease or condition, testing using a framework the at least one first drug/compound to obtain first drug/compound data, wherein the framework is configured based upon at least a) second drug/compound data from within the framework, the second drug/compound data obtained from at least one second drug/compound which is actively approved to treat a targeted disease or condition, b) third drug/compound data from within the framework, the third drug/compound data obtained from at least one third drug/compound which selected from the group consisting of a drug/compound previously approved to treat the targeted disease or condition and a drug/compound previously withdrawn from clinical testing in connection with the targeted disease or condition, and c) integrated drug-to-target information, drug-to-gene information, and protein-to-protein information each relevant to the targeted disease or condition, and comparing the first drug/compound data to the second drug/compound data and the third drug/compound data to determine if the first drug/compound data and/or the third drug/compound data identifies a candidate drug/compound to treat the targeted disease or condition and ranking the first drug/compound data, the second drug/compound data, and the third drug/compound data in an order from most positive to least positive, wherein the most positive is indicative of a drug/compound likely to be the most effective to treat the targeted disease or condition, wherein at least one candidate drug/compound to treat the targeted disease or condition is identified from performing the comparing step.

The present disclosure also includes disclosure of a method of treating breast cancer using donepezil, donepezil hydrochloride, or a variant thereof. In at least one embodiment, the method comprises the step of administering a therapeutically effective dose of donepezil, donepezil hydrochloride, or a variant thereof, to a patient with breast cancer to treat the patient.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a schematic diagrammatic view of a network system in which embodiments of the present disclosure may be utilized;

FIG. 2 shows a block diagram of a computing system (either a server or client, or both, as appropriate), with optional input devices (e.g., keyboard, mouse, touch screen, etc.) and output devices, hardware, network connections, one or more processors, and memory/storage for data and modules, etc. which may be utilized in conjunction with embodiments of the present disclosure;

FIG. 3A shows a chart showing a comparison using a HD dataset and using CMAP dataset on ranking consistency, according to an exemplary embodiment of the present disclosure;

FIG. 3B shows steps of a method in block diagram form, according to an exemplary embodiment of the present disclosure;

FIG. 3C shows a cumulative scope of drugs/compounds in block diagram form, according to an exemplary embodiment of the present disclosure;

FIG. 4 shows a chart showing the effects of donepezil and 4OHtam on in vitro cell line proliferation, according to an exemplary embodiment of the present disclosure;

FIG. 5A shows PETS data for various subgroups of drugs/compounds using HD (drug-protein “high definition”, i.e. well-validated data sets from curation), according to an exemplary embodiment of the present disclosure;

FIG. 5B shows PETS data for various subgroups of drugs/compounds using CMAP (Broad Institute's drug-gene connectivity map data, which can have spotty coverage and biased toward available cell lines), according to an exemplary embodiment of the present disclosure;

FIG. 5C shows PETS data for various subgroups of drugs/compounds using HD without performing pathway modeling, according to an exemplary embodiment of the present disclosure;

FIG. 5D shows PETS data for various subgroups of drugs/compounds using CMAP without performing pathway modeling, according to an exemplary embodiment of the present disclosure;

FIG. 5E shows PETS data for various subgroups of drugs/compounds using HD without the use of PETS simulations, according to an exemplary embodiment of the present disclosure;

FIG. 5F shows PETS data for various subgroups of drugs/compounds using CMAP without the use of PETS simulations, according to an exemplary embodiment of the present disclosure;

FIG. 6 shows a comparison between using HD dataset and using CMAP dataset on ranking consistency categorized in different PETS simulation configurations, according to an exemplary embodiment of the present disclosure;

FIG. 7 shows examples of four basic topological categories, according to exemplary embodiments of the present disclosure; and

FIG. 8 shows charts showing the mean of first-norm differences at perturbation experiments using different goverened parameters and perturbation types, according to an exemplary embodiment of the present disclosure.

An overview of the features, functions and/or configurations of the components depicted in the various figures will now be presented. It should be appreciated that not all of the features of the components of the figures are necessarily described. Some of these non-discussed features, such as various couplers, etc., as well as discussed features are inherent from the figures themselves. Other non-discussed features may be inherent in component geometry and/or configuration.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present disclosure includes disclosure of the identification of donepezil as being a drug useful to treat cancer. Said disclosure includes the use of software applications that when used in connection with analysis of drugs for positive and negative phenotypes for cancer, and the identification of donepezil as a drug to treat breast cancer.

The present disclosure includes disclosure resulting from the use of an integrated pathway model that curates large amounts of data from various public databases for any particular disease. These databases include those for protein-protein interactions, gene expression, gene mutation, chemical structures, drug side effects, and publications. Use of said applications permitted the integration the data, filtering out the statistical noise, and generation predictions of how a specific compound interacts with the proteins within the cell, including the drug target, off-targets, and downstream or upstream proteins. An exemplary end result of the analysis is that a score is assigned for a drug based on its ability to interact with the correct targets while not interacting with undesirable off-targets.

Using said software application(s), a large pool of candidate compounds was analyzed for potential use as a breast cancer treatment. Drugs were analyzed for both the estrogen receptor positive (ER+) and the ER negative (ER−) phenotypes of breast cancer. In the analyses performed, drugs were ranked by their assigned score. In at least one embodiment, which is the scoring mechanism used in this analysis, a score for a drug will fall between −1.0 and +1.0 in regards to the receptors hit by the drug. Any positive score shows a prediction that the drug will have a strong effect against the receptors associated with that particular disease and minimal effects on off-targets, meaning that there will be fewer adverse drug reactions. A score of +1.0 would indicate the “perfect” drug that is 100% effective against the disease targets and 0% effective against non-disease off-targets. While no drug will reach a perfect score, the highest scoring drugs in the analysis are predicted to have the best chance of success in clinical trials.

The present disclosure includes disclosure of a novel pathway-PETS (pathway pharmacological effect on target) framework for drug repurposing by applying the advantages of both “guilt-by-association” and pattern matching techniques. The pathway-PETS framework includes two pairwise-supportive steps: constructing the disease-specific pathway model and developing the model-driven simulation PETS, which takes advantage of the well-annotated pathway model. We therefore sought to create comprehensive pathway models that can provide more insights into drug mechanism. Drug discovery and repurposing for complex diseases such as breast cancer will need to focus on altering entire disease pathways rather than altering single target proteins. By applying the disease pathway model, we not only preserved the target similarity properties but also were able to extend the similarity measurement to more disease-related molecules. With the comprehensive disease pathway model as the input, PETS computes the pattern matching between the drug and the disease for most of the disease-related molecules; thus, the ranking resolution significantly increases. To take the advantage of the comprehensive and rich of feedback loop pathway, we used network mining approach to develop PETS instead of applying well-known logic-gate simulation.

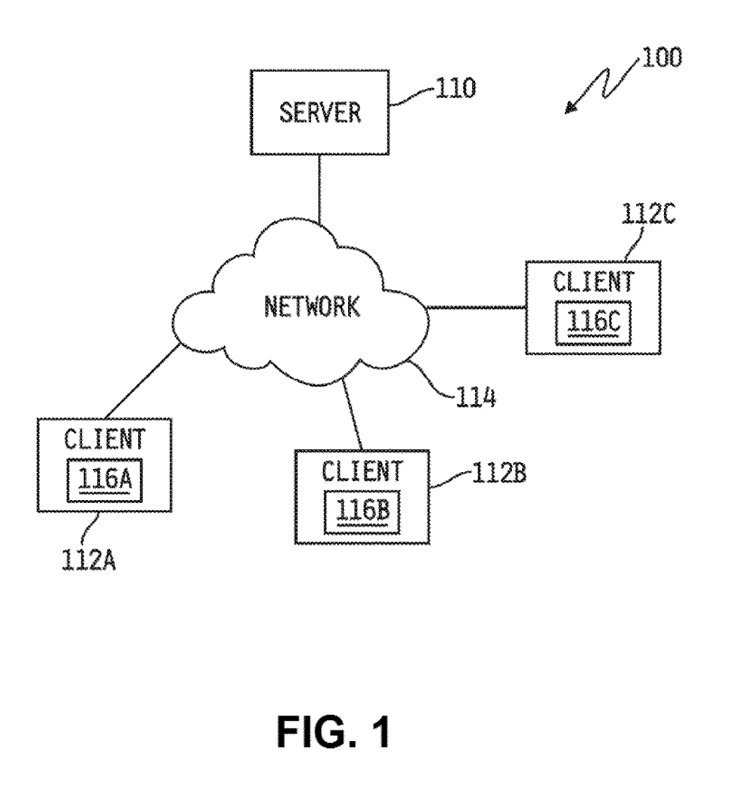

In addition, we propose a repurposing validation framework directly using the clinical trial database on clinicaltrials.gov as a method-independent and end-to-end validation to all repurposing techniques. As can be seen in FIG. 1, in this framework, drugs approved by FDA should achieve high scores in the method and only be variable in a fairly narrow range. Meanwhile, drugs in phase 3 and phase 4 trial may score in a larger range and gain less positive score, compare to FDA approved drugs.

We apply our framework in breast cancer case study because of three important reasons. First, breast cancer is a popular disease among cancer in women. Second, breast cancer is a typical complex disease from the following points of view: multiple subtypes, multiple linked gene mutations and multiple drug side effects. Third, there are no comprehensive breast cancer disease pathway models that provide complete disease mechanisms and include all breast cancer drugs' targeted proteins.

In connection with the aforementioned analysis, and as shown in the table of results identified as Table 1 herein, donepezil hydrochloride (also known as Aricept by Pfizer and Eisai, and generally referenced to herein as donepezil) scored a +0.548 in the ER+ breast cancer model and a +0.641 in the ER− breast cancer model. Table 1 is as follows:

TABLE 1
PETS scores of all drugs

| | | ER+ | | ER− | |
|---|---|---|---|---|---|
| | Cate- | PETS | ER+ | PETS | ER− |
| Drug | gory | score | p-value | score | p-value |
| Anastrozole | D1 | 0.5926 | 0.0299 | 0.6655 | 0.0025 |
| Arzoxifene | D2 | 0.5707 | 0.0025 | 0.6361 | 0.0075 |
| Bleomycin | D3 | −0.5675 | 0.0025 | −0.5999 | 0.0499 |
| Canertinib | D2 | 0.5639 | 0.0025 | 0.6701 | 0.0050 |
| Celecoxib | D4\grave{ } | −0.6375 | 0.0100 | −0.7200 | 0.0025 |
| Conjugated Estrogens | D2 | −0.5255 | 0.0025 | −0.5782 | 0.0474 |
| Corticosterone | D3 | −0.5639 | 0.0150 | −0.0288 | 0.0025 |
| Cycloheximide | D1 | −0.3151 | 0.0025 | −0.0469 | 0.8883 |
| Dasatinib | D4\grave{ } | 0.2986 | 0.0025 | 0.0027 | 1.0000 |
| Daunorubicin | D3 | −0.2562 | 0.0025 | −0.0931 | 0.9989 |
| Dexamethasone | D3 | −0.0647 | 0.9250 | −0.3343 | 0.0025 |
| Diethylstilbestrol | D2\grave{ } | −0.5946 | 0.0025 | −0.6656 | 0.0050 |
| Dihydrotestosterone | D3 | 0.3315 | 0.0025 | −0.6994 | 0.0025 |
| Donepezil | D3 | 0.5479 | 0.0025 | 0.6411 | 0.0125 |
| Dromostanolone | D2\grave{ } | −0.5274 | 0.0025 | −0.5809 | 0.0025 |
| Propionate | | | | | |
| Erbitux | D3 | 0.5646 | 0.0025 | 0.6656 | 0.0125 |
| Estradiol | D2 | −0.4692 | 0.0025 | −0.4791 | 0.0025 |
| Ethinyl Estradiol | D3 | −0.5255 | 0.0025 | −0.5782 | 0.0025 |
| Exemestane | D1 | 0.5926 | 0.0349 | 0.6655 | 0.0075 |
| Fadrozole | D2 | 0.5274 | 0.0025 | 0.5809 | 0.0449 |
| Fenretinide | D2 | 0.6621 | 0.0075 | 0.6651 | 0.0075 |
| Fluorouracil | D1 | −0.2758 | 0.0025 | 0.6767 | 0.0025 |
| Fluoxymesterone | D1 | 0.5255 | 0.0025 | 0.5494 | 0.0025 |
| Flutamide | D3 | −0.3705 | 0.0025 | −0.2799 | 0.0025 |
| Formestane | D2\grave{ } | −0.3918 | 0.0025 | −0.3083 | 0.0025 |
| Fulvestrant | D1 | 0.5255 | 0.0025 | 0.5782 | 0.0274 |
| Hydrocortisone | D3 | −0.5322 | 0.0025 | 0.1330 | 0.0025 |
| Hydroxyurea | D3 | −0.3498 | 0.0025 | 0.5114 | 0.0025 |
| Ixabepilone | D2\grave{ } | −0.5299 | 0.0025 | −0.1558 | 0.0083 |
| Lapatinib | D1 | 0.5021 | 0.0025 | 0.4727 | 0.0025 |
| Letrozole | D1 | 0.5926 | 0.0299 | 0.6655 | 0.0050 |
| Lithium Chloride | D3 | −0.2183 | 0.0025 | 0.6701 | 0.0125 |
| Medrysone | D3 | 0.3055 | 0.0025 | −0.6071 | 0.0200 |
| Melatonin | D2 | 0.5255 | 0.0025 | 0.5782 | 0.0424 |
| Methyl | D3 | 0.0289 | 0.0025 | −0.4346 | 0.0025 |
| Methanesulfonate | | | | | |
| Methylprednisolone | D3 | 0.3055 | 0.0025 | −0.6071 | 0.0175 |
| Miltefosine | D1 | 0.5639 | 0.0025 | 0.6701 | 0.0025 |
| Mitomycin | D3 | −0.0985 | 0.0025 | 0.0837 | 0.9795 |
| Neratinib | D2 | 0.5021 | 0.0025 | 0.4727 | 0.0025 |
| Nocodazole | D3 | 0.6578 | 0.0100 | 0.5506 | 0.0025 |
| Onapristone | D2 | −0.3055 | 0.0025 | 0.6071 | 0.0200 |
| Ondansetron | D4\grave{ } | −0.3055 | 0.0025 | 0.6071 | 0.0249 |
| Paclitaxel | D1 | −0.4196 | 0.0025 | 0.3818 | 0.0025 |
| Pamidronate | D1 | 0.5633 | 0.0025 | 0.6417 | 0.0175 |
| Pirarubicin | D4 | −0.2562 | 0.0025 | −0.0931 | 0.9680 |
| Plicamycin | D3 | 0.4595 | 0.0025 | 0.4664 | 0.0025 |
| Prednisolone | D3 | 0.3055 | 0.0025 | −0.6071 | 0.0324 |
| Prednisone | D3 | 0.3055 | 0.0025 | −0.6071 | 0.0150 |
| Progesterone | D3 | −0.5255 | 0.0025 | −0.5782 | 0.0025 |
| Raloxifene | D1 | 0.4913 | 0.0025 | 0.5021 | 0.0025 |
| Tamoxifen | D1 | 0.5669 | 0.0025 | 0.3820 | 0.0025 |
| Testosterone | D3 | 0.3018 | 0.0025 | −0.5904 | 0.0449 |
| Tetradecanoylphorbol | D4\grave{ } | −0.2776 | 0.0025 | 0.3361 | 0.0025 |
| Acetate | | | | | |
| Thiotepa | D1 | 0.706871 | 0.0050 | 0.60276 | 0.0249 |
| Trastuzumab | D1 | 0.261775 | 0.0025 | 0.101321 | 0.4497 |
| Emtansine | | | | | |
| Trilostane | D3 | −0.57069 | 0.0025 | −0.63611 | 0.0075 |
| Vandetanib | D3 | 0.564589 | 0.0025 | 0.665626 | 0.0025 |
| Velcade | D4\grave{ } | −0.11325 | 0.9058 | −0.66618 | 0.0025 |
| Vinblastine | D1 | 0.585725 | 0.0449 | 0.149739 | 0.0025 |
| Vinflunine | D2 | −0.52992 | 0.0025 | −0.15583 | 0.0162 |
| Avastin | D2\grave{ } | −0.41587 | 0.0025 | 0.529767 | 0.0025 |
| Ethyl Carbamate | D2\grave{ } | −0.52555 | 0.0025 | −0.57822 | 0.0399 |
| Imetelstat | D2\grave{ } | 0.23052 | 0.0025 | 0.058332 | 0.9871 |

This prediction indicates that donepezil is a strong candidate for use on both estrogen receptor phenotypes of breast cancer. Donepezil is a drug that is used for Alzheimer's disease through inhibition of the acetyl cholinesterase receptor. As of the date of filing there present application, there are no ongoing clinical trials or patents for donepezil as a drug for breast cancer, suggesting that donepezil is a strong candidate for drug repurposing. As shown in Table 1 herein, the PETS score is more sensitive to regulation information noise (redirecting and changing signature) than to regulation missing information.

Donepezil, along with a number of other drugs, was tested within an integrated breast cancer specific pathway model of the present disclosure that accelerates drug discovery by having more disease-specific proteins and coverage than any other breast cancer specific pathway. The integrated pathway, in this exemplary embodiment, is comprised of 305 nodes with 63 nodes accounting for drugs mapped onto the pathway. Therefore, and within the tested mode, 63 different sub-pathways were built to represent how each specific drug affects its downstream proteins in a breast cancer specific context. The integrated pathway features 242 nodes for proteins/processes and 472 different edges for protein-protein interactions.

The pathway model disclosed herein increases the utility for evaluating candidate breast cancer drugs when compared to current curated breast cancer pathways. The integrated pathway model is successful in providing a better view for how drugs affect breast cancer pathways. For example, the Tamoxifen pathway from DrugBank only includes four proteins (three cytochromes and one estrogen receptor) and is thus very brief in its coverage. The Tamoxifen pathway retrieved from the integrated breast cancer pathway includes 67 proteins, including the most significant proteins for breast cancer such as BRCA1, ESR1, and P53. This increased specificity for the integrated breast cancer pathway model can provide a better view of molecular mechanisms when studying drug actions.

In addition, the pathway model quality was addressed by recovering known drug-molecular indications given the pathway model and curated target data. Drug-molecule indications of drugs approved for or in trial for breast cancer were queried as observed interactions. Drug-molecule indications using the PETS (Pharmacology Effect on Target Simulator) technique were predicted and compared between the observed interaction and predicted interaction. Among these predictions, and in an exemplary study, 143 predictions match with the observed ones, yielding a prediction accuracy of 78.1%. Specifically, PETS achieved 90%-100% accuracy for 21 drugs, 80%-89% for 6 drug, and 70%-79% for 4 drugs.

Using the model, a PETS technique was applied to the breast cancer case study to demonstrate how the model-driven approach helps predict drug perturbation effects on genes or proteins and to evaluate all candidate drugs' therapeutic effects. An initial task was to predict drug-molecule (or drug-protein in the breast cancer case study) indications, which are not covered in current databases. Therefore, this task can be employed to enhance drug signature databases. With the drug-molecule indications extended in the initial task, an additional task computes the drug's therapeutic score, or PETS score. This latter task evaluates whether or not the drug could be repurposed for a specific disease. Also, and in this latter task, PETS is able to both provide reasonable PETS score to rank the drug's therapy and also suggest some drug repurposing cases that would not have been repurposed easily with conventional methods. This method also accounts for some degree of resistance against noise in the pathway model.

To examine PETS's ranking capability, PETS scores were computed for 63 breast cancer drugs form 3 frameworks: pathway-PETS, PA(−) and PET(−) using the HD dataset and validate PETS's ranking by clinical evidence. To compare the PETS score for each drug with their clinical significance for breast cancer, the 63 drugs were annotated based on clinical evidence and approval status and divided them into five categories, according to explanation in the method section. The first category (D1) includes drugs approved by the FDA for breast cancer. The second category (D2) includes drugs on trials for breast cancer but not yet approved by FDA. The third category (D3) is composed of drugs approved by the FDA for some other disease(s) instead of breast cancer. The fourth category (D4) contains drugs which are not approved neither for breast cancer nor another disease. It was then expected that D1 drugs' PETS scores to be among the highest, followed by drugs' PETS scores in the D2 set. D3 and D4 sets contain possible candidate drugs for repurposing, so it was further expected PETS score for D3 and D4 are variant from strong negative to strong positive.

In the breast cancer ER+ case, PETS is able to give appropriate ranking for most of the well-known therapeutic drugs and suggest candidate drugs for repurposing. Among drugs approved by the FDA for breast cancer (D1), Cycloheximide, Fluorouracil, Ixabepilone and Paclitaxel receive a negative ranking. In fact, Cycloheximide has been known for its toxic effects, and is potentially involved in breast tumor development. In addition, PETS gives eight drugs out of twelve D2 drugs positive scores. D2 drugs receiving negative score are Conjugated Estrogens, Estradiol, Onapristone and Vinflunine. Similar to Cycloheximide, literature findings have asserted the potential risk of Estradiol treatment. Among drugs in the D3 and D4 category, PETS suggests 5 candidate drugs for Breast Cancer repurposing: Donepezil, Erbitux, Nocodazole, Plicamycin and Vandetanib, whose PETS scores are above the average of D1 drugs. Donepezil is primarily used for treatment of Alzheimer's disease since its designed target, ACHE, terminates signal transduction in neuron and muscle cells. In the breast cancer cell line, the ACHE mutation is discovered, and is related to the mutation of breast cancer's specific proteins EPHB4 and MME.

In the breast cancer ER− case, not only is the prediction trend of PETS scores similar to the prediction trend in the ER+ case, but PETS is also is able to identify drugs showing opposite therapeutic effect between the ER+ case and the ER−. These opposite therapeutic predictions show the capability of PETS in disease-specific drug repurposing. Unlike the ER+ subtype, Paclitaxel's PETS score in ER− subtype is positive. The result for Paclitaxel within the present disclosure agrees with the result reported that shows the difference in Paclitaxel between breast cancer ER+ and ER− cells. The score of Tamoxifen is closer to 0, confirming that Tamoxifen is less responsive in ER− treatment than in ER+ treatment. In D3 and D4 sets, PETS suggest eight drugs for repurposing: Donepezil, Erbitux, Hydroxyurea, Lithium Chloride, Nocodazole, Plicamycin, Ondansetron and Vandetanib. Donepezil's primary target, ACHE, is involved in signal transmission termination; thus, Donepezil could induce apoptosis in leukemia cells, which explains the potential therapeutic effect in breast cancer.

The integrated breast cancer pathway model of the present disclosure provides six times more coverage and significantly increased CET protein inclusion when compared to other canonical breast cancer pathways. The exemplary pathway model of the present disclosure was compared to existing breast cancer and cancer specific pathways, and increased CET protein inclusion by nine-fold compared to known pathways, such as the P53 Signaling Pathway. For drug discovery, specifically, it is increasingly important to examine relations between drug targets and effectors to assert the efficiency of the drug. In the Integrated Breast Cancer Pathway (the model pathway of the present disclosure), 62 effectors are reachable by some target, compared to 0 effectors reachable by targets in the other compared pathways. Using CET proteins as a guide increases the utility of the integrated pathway model for evaluating candidate breast cancer drug perturbation effects.

In view of the foregoing, the present disclosure includes disclosure of systems (and related software/algorithms/programs) and methods to identify potential drugs to treat diseases or other conditions.

An exemplary method 300 of the present Application includes some or all of the following steps, which can be performed in any logical order:

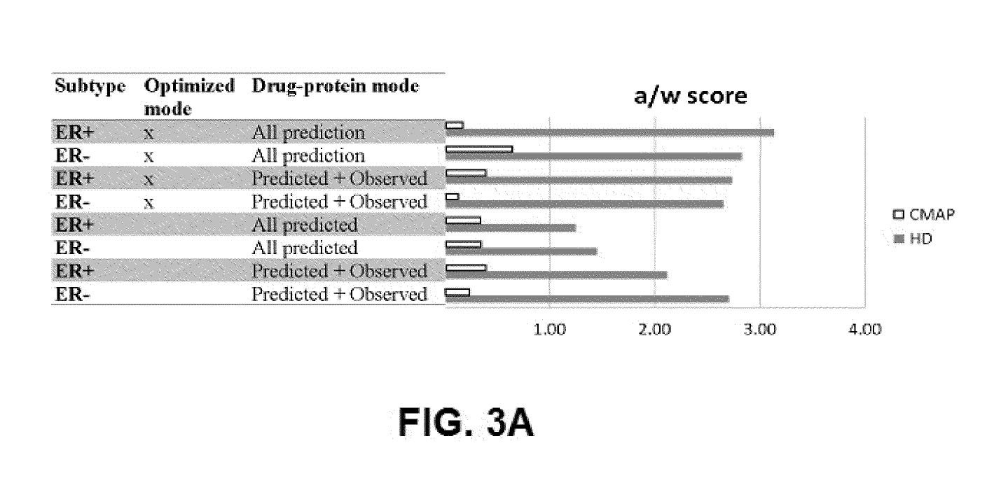

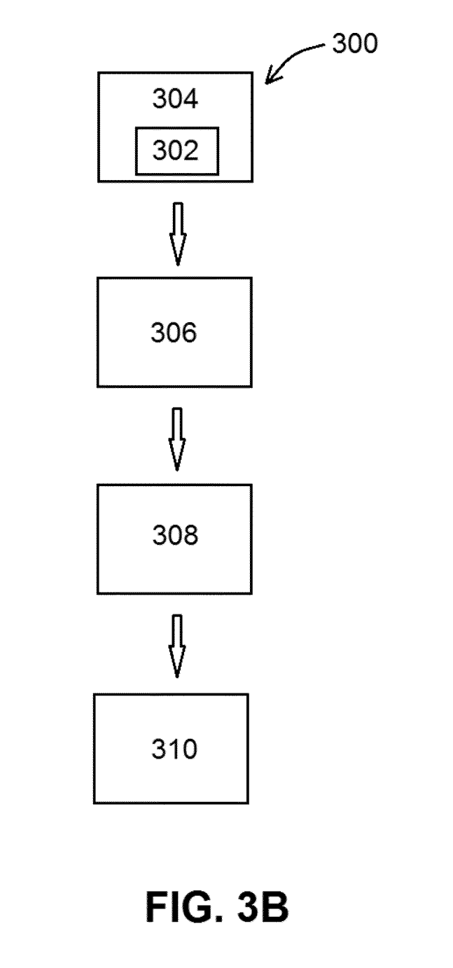

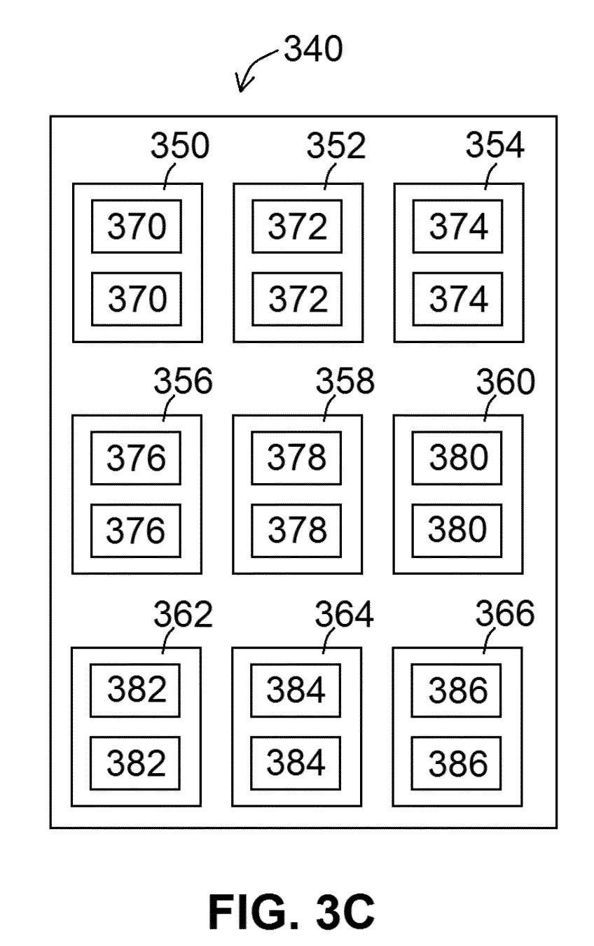

One exemplary step is the step of selecting at least one drug or compound as at least one prospective drug or compound to treat a particular disease or condition—this step is referred to herein as drug/compound selection step 302. This step may be performed to select any of the drugs/compounds referenced herein (also referred to as cumulative scope of drugs/compounds 340, as depicted in FIG. 3C) including, but not limited to, one or more drugs/compounds approved for target 370, one or more drugs/compounds previously approved for target 372, one or more drugs/compounds under clinical testing for target 374, one or more drugs/compounds under pre-clinical study for target 376, one or more drugs/compounds approved for non-target 378, one or more drugs/compounds previously approved for target 380, one or more drugs/compounds under clinical testing for non-target 382, one or more drugs/compounds under pre-clinical study for non-target 384, and/or one or more unapproved drugs/compounds 386, as referenced in further detail herein.

Another exemplary step is the step of identifying an overall group/plurality of drugs or compounds to test using one or more algorithms of the present disclosure—this step is referred to herein as group identification step 304. For example, the overall group/plurality of drugs or compounds can include drugs or compounds (generally referred to herein as identified group 306) within some or all of the following subgroups:

A subgroup of drugs or compounds approved by the FDA (or another applicable drug approval agency) to treat the target disease or condition of interest—this subgroup is referred to as subgroup approved for target 350, comprising one or more drugs/compounds approved for target 370. Drugs/compounds approved for target 370 may also be referred to as being “actively” approved for a particular target.

A subgroup of drugs or compounds withdrawn by the FDA (or another applicable drug approval agency) previously to treat the target disease or condition of interest—this subgroup is referred to as subgroup previously approved for target 352, comprising one or more drugs/compounds previously approved for target 372. Drugs/compounds previously approved for target 372 are therefore not “actively” approved for a particular target.

A subgroup of drugs or compounds under clinical testing to treat the target disease or condition of interest—this subgroup is referred to as subgroup under clinical testing for target 354, comprising one or more drugs/compounds under clinical testing for target 374.

A subgroup of drugs or compounds under pre-clinical study to treat the target disease or condition of interest—this subgroup is referred to as subgroup under pre-clinical study for target 356, comprising one or more drugs/compounds under pre-clinical study for target 376.

A subgroup of drugs or compounds approved by the FDA (or another applicable drug approval agency) to treat a disease or condition of interest other than the target disease or condition—this subgroup is referred to as subgroup approved for non-target 358, comprising one or more drugs/compounds approved for non-target 378.

A subgroup of drugs or compounds withdrawn by the FDA (or another applicable drug approval agency) previously to treat a disease or condition of interest other than the target disease or condition—this subgroup is referred to as subgroup previously approved for non-target 360, comprising one or more drugs/compounds previously approved for target 380.

A subgroup of drugs or compounds under clinical testing to treat a disease or condition of interest other than the target—this subgroup is referred to as subgroup under clinical testing for non-target 362, comprising one or more drugs/compounds under clinical testing for non-target 382.

A subgroup of drugs or compounds under pre-clinical study to treat the disease or condition of interest—this subgroup is referred to as subgroup under pre-clinical study for non-target 364, comprising one or more drugs/compounds under pre-clinical study for non-target 384.

A subgroup of drugs or compounds not approved to treat any disease or condition of interest—this subgroup is referred to as unapproved subgroup 366, comprising one or more unapproved drugs/compounds 386. Subgroup 366, and therefore one or more unapproved drugs/compounds 386 within subgroup 366, may also include drugs/compounds that were previously under clinical or only pre-clinical study (directed to the targeted disease or condition or not directed to the targeted disease or condition) and subsequently withdrawn from said clinica or preclinical study so that it/they is/are no longer “actively” studied.

For example, at least one identified group 306 can include subgroup approved for target 350 (comprising one or more drugs/compounds approved for target 370), a combination of subgroup under clinical testing for target 354 (comprising one or more drugs/compounds under clinical testing for target 374) and subgroup under pre-clinical study for target 356 (comprising one or more drugs/compounds under pre-clinical study for target 376), subgroup approved for non-target 358 (comprising one or more drugs/compounds approved for non-target 378), and unapproved subgroup 366 (comprising one or more unapproved drugs/compounds 386). Another exemplary identified group 306 can include subgroup approved for target 350, comprising one or more drugs/compounds approved for target 370), subgroup previously approved for target 352 (comprising one or more drugs/compounds previously approved for target 372), subgroup under clinical testing for target 354 (comprising one or more drugs/compounds under clinical testing for target 374), subgroup approved for non-target 358 (comprising one or more drugs/compounds approved for non-target 378), subgroup under clinical testing for non-target 362 (comprising one or more drugs/compounds under clinical testing for non-target 382), and subgroup under pre-clinical study for non-target 364 (comprising one or more drugs/compounds under pre-clinical study for non-target 384).

As referenced herein, “drugs/compounds” may refer to the actual physical embodiment of the drugs/compounds themselves, or may refer to a chemical structure, or portions thereof, suitable for testing using a framework as described in further detail herein.

In at least one embodiment of a method 300 of the present disclosure, the method comprises the step of selecting at least one drug or compound as at least one prospective drug or compound to treat a particular disease or condition—this step (as referenced above) is referred to herein as drug/compound selection step 302. Drug/compound selection step 302 may be performed in connection with the performance of an exemplary group identification step 304 of the present disclosure, and is performed to select any of the drugs/compounds referenced herein including, but not limited to, one or more drugs/compounds approved for target 370, one or more drugs/compounds previously approved for target 372, one or more drugs/compounds under clinical testing for target 374, one or more drugs/compounds under pre-clinical study for target 376, one or more drugs/compounds approved for non-target 378, one or more drugs/compounds previously approved for target 380, one or more drugs/compounds under clinical testing for non-target 382, one or more drugs/compounds under pre-clinical study for non-target 384, and/or one or more unapproved drugs/compounds 386. An exemplary method 304 therefore may include performance of an exemplary group identification step 304, whereby various drugs/compounds (as noted above) are selected and tested together.

For example, performance of group identification step 304 may be to identify drugs/compounds within any number of the subgroups listed herein including, but not limited to, subgroup approved for target 350, subgroup previously approved for target 352, subgroup under clinical testing for target 354, subgroup under pre-clinical study for target 356, subgroup approved for non-target 358, subgroup previously approved for non-target 360, subgroup under clinical testing for non-target 362, subgroup under pre-clinical study for non-target 364, and/or unapproved subgroup 366. In at least one method 300 embodiment, one or more drugs/compounds approved for target 370 (within subgroup approved for target 350) are selected as part of group identification step 304 so to obtain statistically positive data in connection with the performance of one or more methods 300, such as, for example, selecting Anastrozole (also known as Arimidex by AstraZeneca) and/or Paclitaxel (also known as Taxol by Bristol-Myers Squibb), as said drugs/compounds are known and approved by the FDA to treat breast cancer. Such drugs/compounds approved for target 370 (within subgroup approved for target 350), may also be referred to herein as falling with category “D1,” as referenced below.

In the present application, several subgroups may be referred to using other reference identifiers. For example, subgroup approved for target 350 may be referred to herein as category “D1,” comprising one or more drugs/compounds approved for target 370. Subgroup under clinical testing for target 354 may be referred to herein as category “D2,” comprising one or more drugs/compounds under clinical testing for target 374. Subgroup previously approved for target 352 may be referred to herein as category “D2′” (D2-prime), comprising one or more drugs/compounds previously approved for target 372. Each of categories D1, D2, and D2′, comprising subgroups 350, 354, and 352 respectively and drugs/compounds 370, 374, and 372, respectively, are all directed to subgroups and/or drugs/compounds directed to a particular target of interest, such as breast cancer or another disease or condition. In addition to the foregoing, subgroup under pre-clinical study for target 356, comprising one or more drugs/compounds under pre-clinical study for target 376, are also directed to a particular target of interest.

Other reference identifiers may be used to refer to subgroups and/or drugs/compounds not currently directed to a particular target of interest. For example, subgroup approved for non-target 358 may be referred to herein as category “D3,” comprising one or more drugs/compounds approved for non-target 378. Subgroup under clinical testing for non-target 362, comprising one or more drugs/compounds under clinical testing for non-target 382, may be referred to herein as category “D4,” while subgroup under pre-clinical study for non-target 364, comprising one or more drugs/compounds under pre-clinical study for non-target 384, may be referred to herein as category “D5.” Subgroups and/or drugs/compounds not currently directed to a particular target of interest, as referenced herein, may also refer to subgroup previously approved for non-target 360, comprising one or more drugs/compounds previously approved for target 380, and/or unapproved subgroup 366, comprising one or more unapproved drugs/compounds 386.

Referring back to exemplary methods 300, other subgroups and drugs/compounds would be tested, as at least one goal of the present disclosure is a system and/or method to test drugs/compounds within subgroups outside of category D1, namely outside of subgroup approved for target 350 (comprising one or more drugs/compounds approved for target 370), so that at least one drug/compound within one other category or subgroup may be identified as a prospective drug/compound that could also potentially be used to treat the target disease or condition of interest. Said other drugs/compounds, and potentially subcategories of the same, can be determined using a drug-drug chemical similarity search, such as from PubChem searches of drugs within category D1 and/or D2, and/or using a drug-drug shared target search, such as by using a drug-target database such as DGIdb), and/or using a drug-drug shared side effects or shared indication search, such as by using CIDER or ATC does, or drug-drug similarity from shared disease similarity (from diseaseome work, for example). Said “candidate” drugs/compounds and potential subgroups comprise drugs/compounds within categories D3, D4, and/or D5, and comprise performance of an exemplary group identification step 304.

Once the desired group of drugs/compounds has been identified pursuant to group identification step 304, exemplary methods of the present disclosure include the step of testing the drugs/compounds using an in silico framework of the present disclosure, referred to herein as an exemplary testing step 306. Said testing step 306 is used to generate data in connection with each tested drug/compound, which can then be compared (data to data comparison) to potentially identify if at least one of the drugs/compounds that was not currently approved to treat the targeted disease or condition may be effective to treat the targeted disease or condition. Said comparison may be referred to herein as an exemplary comparison step 308. Should one or more candidate drugs/compounds result from step 308, an exemplary method of the present disclosure (as shown in FIG. 3B, for example), can comprise the step of administering the at least one candidate drug/compound to a patient having the targeted disease or condition to treat the targeted disease or condition (an exemplary administration step 310).

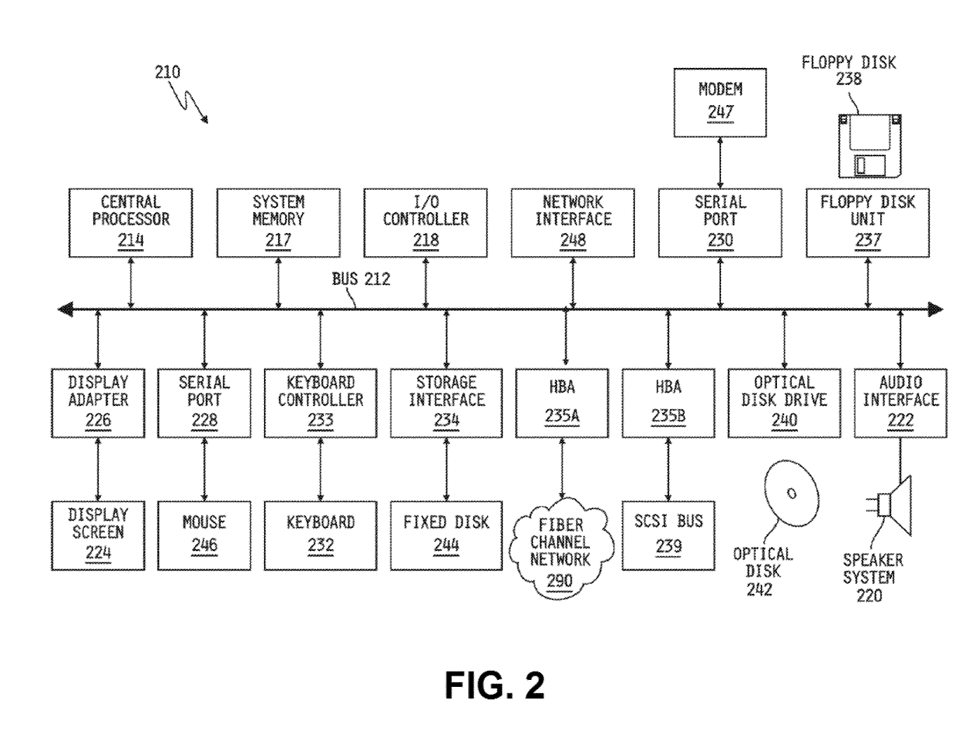

The various methods referenced herein can be performed using any number of algorithms, data aggregations, databases, etc., as referenced herein. Said items (generally referred to herein as “software”) can be performed using any number of pieces of hardware known in the art, as noted in FIGS. 1 and 2 referenced below.

The detailed descriptions which follow are presented in part in terms of algorithms and symbolic representations of operations on data bits within a computer memory representing drug/compound and/or subgroup information referenced herein and populated into network models. A computer generally includes a processor for executing instructions and memory for storing instructions and data. When a general purpose computer has a series of machine encoded instructions stored in its memory, the computer operating on such encoded instructions may become a specific type of machine, namely a computer particularly configured to perform the operations embodied by the series of instructions. Some of the instructions may be adapted to produce signals that control operation of other machines and thus may operate through those control signals to transform materials far removed from the computer itself. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present disclosure relates to a method and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher level coding of the instructions that is interpreted to obtain the actual computer code. The software module may also include a hardware component, wherein some aspects of the algorithm are performed by the circuitry itself rather as a result of an instruction.

The present disclosure also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus unless explicitly indicated as requiring particular hardware. In some cases, the computer programs may communicate or relate to other programs or equipment through signals configured to particular protocols which may or may not require specific hardware or programming to interact. In particular, various general purpose machines may be used with programs written in accordance with the teachings herein, or it may prove more convenient to construct more specialized apparatus to perform the required method steps. The required structure for a variety of these machines will appear from the description below.

The present disclosure may deal with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment. Similar to a process is an agent (sometimes called an intelligent agent), which is a process that gathers information or performs some other service without user intervention and on some regular schedule. Typically, an agent, using parameters typically provided by the user, searches locations either on the host machine or at some other point on a network, gathers the information relevant to the purpose of the agent, and presents it to the user on a periodic basis. A “module” refers to a portion of a computer system and/or software program that carries out one or more specific functions and may be used alone or combined with other modules of the same system or program.

The term “desktop” means a specific user interface which presents a menu or display of objects with associated settings for the user associated with the desktop. When the desktop accesses a network resource, which typically requires an application program to execute on the remote server, the desktop calls an Application Program Interface, or “API”, to allow the user to provide commands to the network resource and observe any output. The term “Browser” refers to a program which is not necessarily apparent to the user, but which is responsible for transmitting messages between the desktop and the network server and for displaying and interacting with the network user. Browsers are designed to utilize a communications protocol for transmission of text and graphic information over a world wide network of computers, namely the “World Wide Web” or simply the “Web”. Examples of Browsers compatible with the present invention include the Internet Explorer program sold by Microsoft Corporation (Internet Explorer is a trademark of Microsoft Corporation), the Opera Browser program created by Opera Software ASA, or the Firefox browser program distributed by the Mozilla Foundation (Firefox is a registered trademark of the Mozilla Foundation). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

The terms “personal digital assistant” or “PDA”, as defined above, means any handheld, mobile device that combines computing, telephone, fax, e-mail and networking features. The terms “wireless wide area network” or “WWAN” mean a wireless network that serves as the medium for the transmission of data between a handheld device and a computer. The term “synchronization” means the exchanging of information between a first device, e.g. a handheld device, and a second device, e.g. a desktop computer, either via wires or wirelessly. Synchronization ensures that the data on both devices are identical (at least at the time of synchronization).

In wireless wide area networks, communication primarily occurs through the transmission of radio signals over analog, digital cellular or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), Third Generation (wideband or “3G”), Fourth Generation (broadband or “4G”), personal digital cellular (“PDC”), or through packet-data technology over analog systems such as cellular digital packet data (CDPD”) used on the Advance Mobile Phone Service (“AMPS”).

The terms “wireless application protocol” or “WAP” mean a universal specification to facilitate the delivery and presentation of web-based data on handheld and mobile devices with small user interfaces. “Mobile Software” refers to the software operating system which allows for application programs to be implemented on a mobile device such as a mobile telephone or PDA. Examples of Mobile Software are Java and Java ME (Java and JavaME are trademarks of Sun Microsystems, Inc. of Santa Clara, Calif.), BREW (BREW is a registered trademark of Qualcomm Incorporated of San Diego, Calif.), Windows Mobile (Windows is a registered trademark of Microsoft Corporation of Redmond, Wash.), Palm OS (Palm is a registered trademark of Palm, Inc. of Sunnyvale, Calif.), Symbian OS (Symbian is a registered trademark of Symbian Software Limited Corporation of London, United Kingdom), ANDROID OS (ANDROID is a registered trademark of Google, Inc. of Mountain View, Calif.), and iPhone OS (iPhone is a registered trademark of Apple, Inc. of Cupertino, Calif.), and Windows Phone 7. “Mobile Apps” refers to software programs written for execution with Mobile Software.

FIG. 1 is a high-level block diagram of a computing environment 100 according to one embodiment. FIG. 1 illustrates server 110 and three clients 112 connected by network 114. Only three clients 112 are shown in FIG. 1 in order to simplify and clarify the description. Embodiments of the computing environment 100 may have thousands or millions of clients 112 connected to network 114, for example the Internet. Users (not shown) may operate software 116 on one of clients 112 to both send and receive messages network 114 via server 110 and its associated communications equipment and software (not shown).

FIG. 2 depicts a block diagram of computer system 210 suitable for implementing server 110 or client 112. Computer system 210 includes bus 212 which interconnects major subsystems of computer system 210, such as central processor 214, system memory 217 (typically RAM, but which may also include ROM, flash RAM, or the like), input/output controller 218, external audio device, such as speaker system 220 via audio output interface 222, external device, such as display screen 224 via display adapter 226, serial ports 228 and 230, keyboard 232 (interfaced with keyboard controller 233), storage interface 234, disk drive 237 operative to receive floppy disk 238, host bus adapter (HBA) interface card 235A operative to connect with Fiber Channel network 290, host bus adapter (HBA) interface card 235B operative to connect to SCSI bus 239, and optical disk drive 240 operative to receive optical disk 242. Also included are mouse 246 (or other point-and-click device, coupled to bus 212 via serial port 228), modem 247 (coupled to bus 212 via serial port 230), and network interface 248 (coupled directly to bus 212).

Bus 212 allows data communication between central processor 214 and system memory 217, which may include read-only memory (ROM) or flash memory (neither shown), and random access memory (RAM) (not shown), as previously noted. RAM is generally the main memory into which operating system and application programs are loaded. ROM or flash memory may contain, among other software code, Basic Input-Output system (BIOS) which controls basic hardware operation such as interaction with peripheral components. Applications resident with computer system 210 are generally stored on and accessed via computer readable media, such as hard disk drives (e.g., fixed disk 244), optical drives (e.g., optical drive 240), floppy disk unit 237, or other storage medium, which may be referred to herein as non-transitory, tangible computer readable storage media. Additionally, applications may be in the form of electronic signals modulated in accordance with the application and data communication technology when accessed via network modem 247 or interface 248 or other telecommunications equipment (not shown).

Storage interface 234, as with other storage interfaces of computer system 210, may connect to standard computer readable media for storage and/or retrieval of information, such as fixed disk drive 244. Fixed disk drive 244 may be part of computer system 210 or may be separate and accessed through other interface systems. Modem 247 may provide direct connection to remote servers via telephone link or the Internet via an internet service provider (ISP) (not shown). Network interface 248 may provide direct connection to remote servers via direct network link to the Internet via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 2 need not be present to practice the present disclosure. Devices and subsystems may be interconnected in different ways from that shown in FIG. 2. Operation of a computer system such as that shown in FIG. 2 is readily known in the art and is not discussed in detail in this application. Software source and/or object codes to implement the present disclosure may be stored in computer-readable storage media such as one or more of system memory 217, fixed disk 244, optical disk 242, or floppy disk 238. The operating system provided on computer system 210 may be a variety or version of either MS-DOS® (MS-DOS is a registered trademark of Microsoft Corporation of Redmond, Wash.), WINDOWS® (WINDOWS is a registered trademark of Microsoft Corporation of Redmond, Wash.), OS/2® (OS/2 is a registered trademark of International Business Machines Corporation of Armonk, N.Y.), UNIX® (UNIX is a registered trademark of X/Open Company Limited of Reading, United Kingdom), Linux®. (Linux is a registered trademark of Linus Torvalds of Portland, Oreg.), or other known or developed operating system. In some embodiments, computer system 210 may take the form of a tablet computer, typically in the form of a large display screen operated by touching the screen. In tablet computer alternative embodiments, the operating system may be iOS® (iOS is a registered trademark of Cisco Systems, Inc. of San Jose, Calif., used under license by Apple Corporation of Cupertino, Calif.), Android®. (Android is a trademark of Google Inc. of Mountain View, Calif.), Blackberry®. Tablet OS (Blackberry is a registered trademark of Research In Motion of Waterloo, Ontario, Canada), webOS (webOS is a trademark of Hewlett-Packard Development Company, L.P. of Texas), and/or other suitable tablet operating systems.

Moreover, regarding the signals described herein, those skilled in the art recognize that a signal may be directly transmitted from a first block to a second block, or a signal may be modified (e.g., amplified, attenuated, delayed, latched, buffered, inverted, filtered, or otherwise modified) between blocks. Although the signals of the above described embodiments are characterized as transmitted from one block to the next, other embodiments of the present disclosure may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

### In Vitro Validation

We performed wet lab in vitro validation of the PETS scores for two drugs and found inhibition of ER+ and ER− breast cancer cell lines in manners consistent with the predictions.

### Materials and Methods

In vitro cell line proliferation assays. MCF7 and SK-BR-3 breast cancer cell lines were provided by the American Type Culture Collections (ATCC; Manassas, Va.) and cultured in complete medium (high glucose DMEM supplemented with 10% fetal bovine serum, L-glutamine, and pen/strep antibiotics). Drugs were purchased from Sigma-Aldrich (St. Louis, Mo.). Proliferation assays were performed as previously described with minor modifications. Cells were seeded at 5×10³ cells per well in a 96 well plate in the morning. Escalating doses of 4-hydroxytamoxifen (4OHtam) and donepezil, along with DMSO (less than 0.1%) as matching vehicle controls, were added to the cells in complete medium four hours after plating. The plates were incubated at 37° C./5% CO₂ for 96 hours. Cell proliferation was analyzed using MTS reagent (Promega; Madison, Wis.) according to manufacturer's protocol.

### Results—Donepezil and 4-Hydorxytamoxifen Inhibited Breast Cancer Cell Line Proliferation In Vitro.

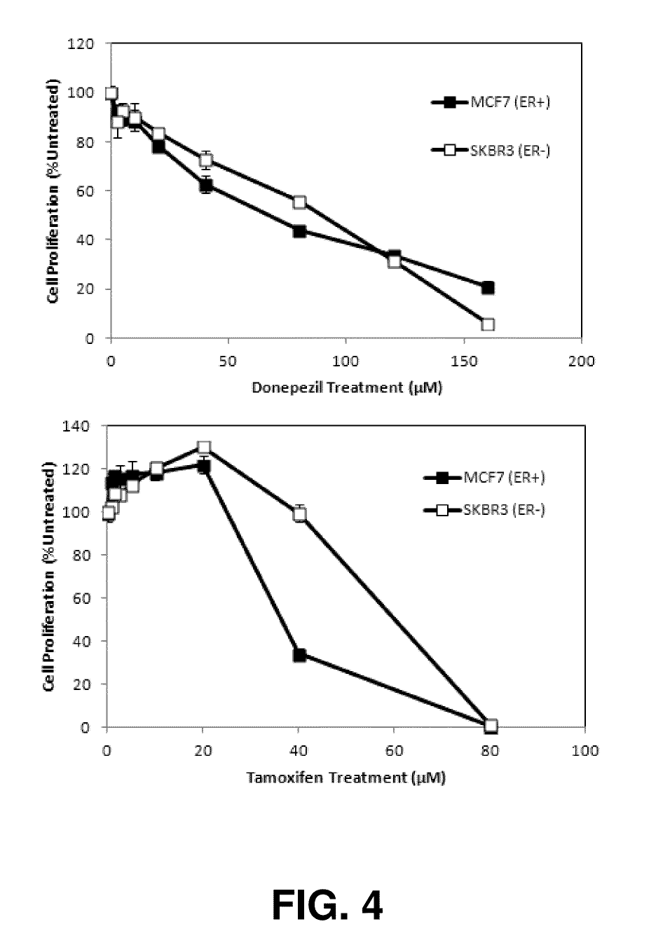

Donepezil was selected from the list of predicted drug candidates for wet lab in vitro validation as the result of the high PETS scores for both ER− and ER+ breast cancer and the fact that Donepezil has never before been analyzed for breast cancer. Tamoxifen was selected as a currently used breast cancer drug for comparison. Because the inactive tamoxifen is metabolized to its active form 4OHtam in the liver, we used 4OHtam for wet lab validation. The ER+ breast cancer cell line MCF7 and the ER− cell line SKBR3 were treated for 96 hours with escalating doses of 4OHtam and donepezil. We observed a dose dependent inhibition of cell line proliferation with both drugs on both cell lines, as shown in FIG. 4. FIG. 4 shows the effects of donepezil and 4OHtam on in vitro cell line proliferation, where MCF7 and SKBR3 were treated with escalating doses of 4OHtam (top) and donepezil (bottom) for 96 hours in complete medium. Cell proliferation was measured using the MTS assay according to manufacturer's protocol. The results are representative of three separate triplicate experiments run in two separate laboratories.

Inhibition by 4OHtam was significantly greater with the ER+ MCF7 cells (IC₅₀=31.2±4.9 μmol/L) than the ER− SKBR3 cells (IC₅₀=55.7±4.2 μmol/L, p=0.003). This is consistent with our PETS scores as the score was higher for ER+ cancer (0.5669) than for ER− cancer (0.3820) as identified in Table 1 and depicted in FIG. 4. These results are also consistent with historical clinical observations as tamoxifen is only used for patients with ER+ breast cancer. Donepezil inhibited both the ER+ MCF7 (IC50=72.9±5.6 μmol/L) and the ER− SKBR3 (84.6±4.4 μmol/L) with similar levels of potency that were also consistent with our PETS predictions as identified in Table 1 and depicted in FIG. 4.

### Discussion

Donepezil and Tamoxifen were selected from our list of analyzed drugs for preliminary wet lab in vitro validation of the PETS scores. Donepezil is a drug that is currently used for Alzheimer's disease under the trade name ARICEPT® and has never previously been reported as a potential candidate for breast cancer. We have identified Donepezil as a promising candidate for breast cancer with high PETS scores for both the ER+ (0.5479) and ER− (0.6411) phenotypes. We selected tamoxifen as a comparison control due to its being currently used to treat patients with ER+ breast cancer. The active metabolite 4OHtam was used in the in vitro assays rather than the parent tamoxifen compound. We observed 4OHtam inhibition of both the ER+ and ER− cell lines in a manner that was consistent with our PETS scores as well as the clinical setting in that the more potent inhibition was with the ER+ cell line as shown in FIG. 4. For Donepezil, the inhibition was similar with both cell line phenotypes, which was also consistent with our PETS scores. However, the dosage required for Donepezil for inhibition was higher for both phenotypes than the 4OHtam dosage required even though the PETS scores were higher for Donepezil. This could be due to multiple factors.

First, inactive tamoxifen requires metabolizing in the liver to the active 4OHtam form to be effective. It is possible that donepezil could also be metabolized, resulting in more active molecules. The PETS score is developed with the basis that the patients represent the “best case scenario” as far as genetics are concerned. There is a significant population of women with mutations in their CYP2D6 gene that codes for Cytochrome P450 2D6 enzyme that is responsible for metabolizing tamoxifen. Patients with these mutations have decreased or non-existent metabolism of tamoxifen and are resistant to the drug.

Second, the efficacy of the drug is only a part of the analysis that generates a PETS score. The toxicity of a drug is also a critical factor that comprises part of the PETS score. Tamoxifen treatment has the potential to lead to severe side effects including the development of endometrial cancer. Conversely, Donepezil has been given to patients with doses up to 23 mg/day with the worst adverse drug reactions being transient nausea and vomiting. It is likely that the reduced side effects combined with the efficacy of Donepezil lead to a high PETS score and the severe side effects caused a decrease in the Tamoxifen score. Taken together, the significantly reduced toxicity and similar efficacy suggests that donepezil is a promising repositioning candidate for breast cancer.

For comparison, Anastrozole (also known as Arimidex by AstraZeneca) and Paclitaxel (also known as Taxol by Bristol-Myers Squibb) are drugs that have been approved for breast cancer by the FDA. Anastrozole was scored at +0.583 for ER+ breast cancer and +0.535 for ER− breast cancer. Paclitaxel scored +0.525 for ER+ and 0.580 for ER−. In both of these cases, the scores were similar to those of donepezil.

Donepezil hydrochloride was initially patented within U.S. Pat. No. 4,895,841, which included the following claimed cyclic amine compound formula:

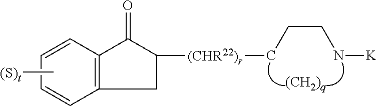

wherein r is an integer of 1 to 10, R²² is hydrogen or methyl, and the R²² radicals can be the same or different when r is from 2 to 10, wherein K is phenylalkyl or phenylalkyl having a substituent on the phenyl ring, wherein S is hydrogen or a substituent on the phenyl ring, and wherein t is an integer of 1 to 4, with the proviso that (S)ₜ can be a methylenedioxy group or an ethylenedioxy group joined to two adjacent carbon atoms of the phenyl ring, and q is an integer of 1 to 3. The claimed cyclic amine compound also included a pharmacologically acceptable salt thereof. In view of the foregoing, and in view of the present disclosure including disclosure of the identification of donepezil hychloride as a strong candidate for use in connection with the treatment of breast cancer, the present disclosure also includes the identification of the above-referenced formula, and pharmacologically acceptable salts thereof. Furthermore, the present disclosure includes disclosure of any of the aforementioned formulas, wherein one or more of the following applies:
q is 2;
K is benzyl, m-nitrobenzyl or m-fluorobenzyl;
S is lower alkyl having 1 to 6 carbon atoms or lower alkoxy having 1 to 6 carbon atoms;
S is methoxy and t is an integer of from 1 to 3; and/or
r is an integer of 1 to 3.

Furthermore, any number of the following compounds are included within the scope of the present disclosure:
1-benzyl-4-((5,6-dimethoxy-1-indanon)-2-yl)methylpiperidine;
1-benzyl-4-((5-methoxy-1-indanon)-2-yl)methylpiperidine;
1-benzyl-4-((5,6-diethoxy-1-indanon)-2-yl)methylpiperidine;
1-benzyl-4-((5,6-methylenedioxy-1-indanon)-2-yl)methylpiperidine;
1-(m-nitrobenzyl)-4-((5,6-dimethoxy-1-indanon)-2-yl)methylpiperidine;
1-(m-fluorobenzyl)-4-((5,6-dimethoxy-1-indanon)-2-yl)methylpiperidine;
1-benzyl-4-((5,6-dimethoxy-1-indanon)-2-yl)propylpiperidine; and
1-benzyl-4-((5-isopropoxy-6-methoxy-1-indanon)-2-yl)methylpiperidine.

Donepezil hydrochloride is also known by its IUPAC name of (RS)-2-[(1-benzyl-4-piperidyl)methyl]-5,6-dimethoxy-2,3-dihydroinden-1-one, having the following structure:

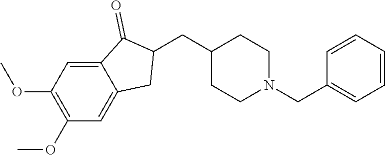 [SMILES: COc1cc2c(cc1OC)C(=O)C(CC1CCN(Cc3ccccc3)CC1)C2]

In view of the foregoing disclosure, it is clear that the present pathway model of the present disclosure, when used consistent with the aforementioned testing, facilitated the identification of donepezil as a candidate breast cancer drug. Donepezil, having certain scores as noted above, is hereby identified as a target drug to treat breast cancer given the similar results of known and used breast cancer treatment drugs when said drugs were also tested within the present model. Furthermore, the present disclosure includes disclosure of a model that when a certain pathway is identified and tested within said model, such as a breast cancer pathway, various scores can be determined and compared to one another across various drugs to determine whether or not a compound not currently known as being effective to treat a particular disease or disorder could be effective to treat the same, such as the case with donepezil being identified as a target for the treatment of breast cancer.

New therapeutic strategies focusing on targeting entire cellular pathways instead of a few proteins may provide an advantage in fighting complex diseases. Using a pathway oriented approach can potentially help examine a drug's action in greater detail. To take advantage of prior knowledge from the pathway for drug repurposing, we have proposed a model-driven drug repurposing algorithm called PETS. It differs from previous GSEA-like ranking algorithms, which are based on gene or gene-set correlation while ignoring underlying connections. The framework can be used for both prediction of drug-molecular effects and ranking drug therapy. PETS could be employed in different disease expression profile to evaluate the drug therapy at the subtype level, which could be further used to personalize medicine. In addition, employing all computer-supported functions such as all prediction mode and pathway optimization enhances ranking performance.

Our framework is suitable for evaluating drug efficacy, a major reason for drug success, by using Rp scores and eliminating many effectors with little relevance to efficacy. The side effect aspect or pharmacodynamics aspect still needs to be modeled separately. However, by combining molecular specified for side effects and cellular processes into the pathway model, we can extend the usage of pathway-PETS framework to evaluate drug side effect and drug's impact on cellular mechanism. To apply the framework to evaluate drug combination, pathway-PETS should be modified considering drugs' direct interaction.

Although PETS is an iterative algorithm and is unable to take advantage of multi-processor machines, it can still achieve real-time performance given that the pathway model is often small and memory-fit. In addition, PETS could be executed in parallel for testing multiple drug-target designs in future drug development, enabling the possibility of extending PETS into the software level.

From wet lab experiments, we observed 4OHtam inhibition of both the ER+ and ER− cell lines in a manner that was consistent with our PETS scores as well as the clinical setting in that the more potent inhibition was with the ER+ cell line, as shown in FIG. 4. For Donepezil, the inhibition was similar with both cell line phenotypes, which was also consistent with our PETS scores.

### EXAMPLE

In this exemplary study, we constructed an integrated high-throughput definition (HD) dataset of drug-molecular interactions for two purposes. First, the HD dataset via manual target-curation provided the drug-target input data to run the PETS algorithm. Second, the HD dataset provided observed drug-molecular indications as the baseline to compare the predicted drug-molecular indication via the disease pathway model. Thus, the HD dataset served in the pathway-quality assessment task during pathway construction.

We integrated the HD dataset from DrugBank and STITCH. For each drug-molecular indication in DrugBank, we assigned a confidence score from −1000 to 1000 based on the indication description and Table 2, noted below:

TABLE 2
Assigned confidence score for drug-molecular
indication in DrugBank and STITCH

| | DrugBankAssigned | STITCH |
|---|---|---|
| drug-molecular indication | confidence score | multiple factor |
| activator | 1000 | 1 |
| adduct | 500 | 0.5 |
| agonist | 1000 | 1 |
| allosteric modulator | 0 | 0 |
| antagonist | −1000 | −1 |
| antibody | 0 | 0 |
| binder | 0 | 0 |
| chaperone | 1000 | 1 |
| chelator | 0 | 0 |
| cleavage | −1000 | −1 |
| cofactor | 1000 | 1 |
| component of | 0 | 0 |
| cross-linking/alkylation | 0 | 0 |
| incorporation into and | −1000 | −1 |
| destabilization | | |
| inducer | 1000 | 1 |
| inhibitor | −1000 | −1 |
| inhibitor, competitive | −1000 | −1 |
| inhibitory allosteric modulator | −1000 | −1 |
| intercalation | 0 | 0 |
| inverse agonist | −1000 | −1 |
| ligand | 0 | 0 |
| metabolizer | 0 | 0 |
| modulator | 0 | 0 |
| multitarget | 0 | 0 |
| negative modulator | −1000 | −1 |
| neutralizer | 0 | 0 |
| other | 0 | 0 |
| other/unknown | 0 | 0 |
| partial agonist | 1000 | 1 |
| partial antagonist | −1000 | −1 |
| positive allosteric modulator | 1000 | 1 |
| potentiator | 1000 | 1 |
| product of | 0 | 0 |
| reducer | −1000 | −1 |
| stimulator | 1000 | 1 |
| suppressor | −1000 | −1 |
| unknown | 0 | 0 |
| (other terms) | 0 | 0 |

Since STITCH assigns the confidence score for drug-molecular indications from 0 to 1000, we map the drug-molecular interactions in STITCH with the multiple factor in Table 2 and multiply STITCH-assigned confidence score with the multiple factor. For duplicated drug-molecular entries in the HD dataset, we averaged the confidence score of the duplicated entries as the final confidence score for the drug-molecular indication. We filtered out the indication in which confidence score is between −300 and 300. As a result, the HD dataset contains 822905 drug-molecular indications from 357950 drugs and 8098 molecules. Compare with similar well-known CMap (build 2) dataset with 1309 drugs. In this study, HD dataset contributes 709 drug-molecular indications; meanwhile CMAP only contributes 511 drug-molecular indications. Thus, HD dataset has significantly more coverage.

### Determine Significant Disease Proteins

To build the integrated pathway model, the C2MAPS webserver was used. Initially, when breast cancer was searched into the C2MAPS webserver, an output of 500 different drug-protein relations for 102 unique proteins was given. The webserver uses the Rp score to measure the importance of the proteins associated with a specific disease. The Rp scores for these proteins ranged from 169.82 to 0.56. A cutoff of 2 or more was used to determine the proteins that should be included from C2MAPS. The most important proteins were determined for Breast Cancer and are called CET proteins, which are all categorized into three types. Type I proteins are considered the highest ranking for CET proteins and contain curated proteins from C2MAPS and OMIM. Type II CET proteins are known effectors for drugs being tested on the pathway. Type III CET proteins are known targets for drugs being tested on the pathway.

Construct the Pathway with CET Proteins

After generating a list of CET proteins for breast cancer, Type I proteins were collectively used as a query search against the Human Pathway Database, an integrated human pathway database that provides pathways from NCI Pathway Interaction Database (PID), Reactome, BioCarta, KEGG and Protein Lounge. This method yielded a comprehensive list of important pathways related to Breast Cancer. We manually assembled molecular interactions based on these pathways and only sub pathways with seed proteins were considered. For every seed protein, the entire path-length of the protein is considered from the pathway source. To ensure a high quality integrated pathway, we used physical interactions that are supported by at least two of the seed pathways. If it was difficult to retrieve overlap information from at least two different seed pathways for a particular edge, we followed a methodology developed by Yuryev et al. in which we relaxed the threshold for pathway references and instead used a PubMed literature reference.

### Expand the Pathway to Ensure Adequate Coverage

In this example, and to ensure that there were no missing edges on the pathway, the STRING database was used to find missing protein-protein interactions. All seed proteins for breast cancer were inputted as one query on STRING. STRING then outputs a network model and the “actions view” option provides some directionality information. If any edge interaction information was missing for the seed proteins, as determined by STRING, then the information was integrated onto the breast cancer pathway model.

### Selecting the Drug List

We selected a drug list to be the initial drug list. After that, from each drug in the initial drug list, we built 3 drug similarity networks for 3 similarities: shared target, shared side effect and similar chemical structure. We searched target information in DrugBank, Therapeutic Target Database (TTD) and Matador. We connected two drugs in the shared target similarity network if and only if two drugs share at least one target. We searched for side effect information from SIDER2 database and connected two drugs in the side effect similarity network as we did for shared target. For chemical similarity, we searched every drug in the initial drug list in DrugBank and PubChem databases and selected the top 5 drugs having the closest chemical similarity score to drugs in the initial list. We only chose drugs which are one step away from drugs in the initial drug list in every drug similarity network. The drug list after this expansion contained 82 drugs. We manually curated the target information for these 82 drugs and removed drugs having none or ambiguous target information. There are 68 drugs having clear target information as can be seen in Table 3, noted below:

TABLE 3
pₐₗₜₑᵣ of the score for 63 drugs using perturbation pathway

| | | change | | |
|---|---|---|---|---|
| | Cate- | regulation | remove | redirect |
| Drug | gory | type | regulation | regulation |
| Anastrozole | D1 | 0.08 | 0.04 | 0.155 |
| Arzoxifene | D2 | 0 | 0 | 0 |
| Bleomycin | D3 | 0.04 | 0 | 0.015 |
| Canertinib | D2 | 0.07 | 0.045 | 0.1 |
| Celecoxib | D4′ | 0.145 | 0.015 | 0.02 |
| Conjugated Estrogens | D2 | 0 | 0 | 0 |
| Corticosterone | D3 | 0.105 | 0.015 | 0.335 |
| Cycloheximide | D1 | 0 | 0 | 0.005 |
| Dasatinib | D4′ | 0.24 | 0.14 | 0.245 |
| Daunorubicin | D3 | 0.17 | 0.045 | 0.075 |
| Dexamethasone | D3 | 0.165 | 0.29 | 0.37 |
| Diethylstilbestrol | D2′ | 0 | 0 | 0 |
| Dihydrotestosterone | D3 | 0.1 | 0.02 | 0.02 |
| Donepezil | D3 | 0.15 | 0.015 | 0.055 |
| Dromostanolone Propionate | D2′ | 0 | 0 | 0 |
| Erbitux | D3 | 0.26 | 0 | 0.045 |
| Estradiol | D2 | 0 | 0 | 0 |
| Ethinyl Estradiol | D3 | 0 | 0 | 0 |
| Exemestane | D1 | 0.08 | 0.04 | 0.155 |
| Fadrozole | D2 | 0 | 0 | 0 |
| Fenretinide | D2 | 0.205 | 0.055 | 0.34 |
| Fluorouracil | D1 | 0.16 | 0.105 | 0.15 |
| Fluoxymesterone | D1 | 0 | 0 | 0 |
| Flutamide | D3 | 0.06 | 0 | 0 |
| Formestane | D2′ | 0 | 0 | 0 |
| Fulvestrant | D1 | 0 | 0 | 0 |
| Hydrocortisone | D3 | 0.135 | 0.085 | 0.115 |
| Hydroxyurea | D3 | 0.1 | 0.02 | 0.145 |
| Ixabepilone | D2′ | 0.255 | 0.055 | 0.14 |
| Lapatinib | D1 | 0.305 | 0 | 0.02 |
| Letrozole | D1 | 0.08 | 0.04 | 0.155 |
| Lithium Chloride | D3 | 0.16 | 0.01 | 0.005 |
| Medrysone | D3 | 0.1 | 0.055 | 0.055 |
| Melatonin | D2 | 0 | 0 | 0 |
| Methyl Methanesulfonate | D3 | 0.3 | 0.345 | 0.39 |
| Methylprednisolone | D3 | 0.1 | 0.055 | 0.055 |
| Miltefosine | D1 | 0.07 | 0.045 | 0.1 |
| Mitomycin | D3 | 0.49 | 0.465 | 0.71 |
| Neratinib | D2 | 0.305 | 0 | 0.02 |
| Nocodazole | D3 | 0 | 0 | 0.005 |
| Onapristone | D2 | 0.1 | 0.055 | 0.055 |
| Ondansetron | D4′ | 0.1 | 0.055 | 0.055 |
| Paclitaxel | D1 | 0.29 | 0.12 | 0.295 |
| Pamidronate | D1 | 0.345 | 0.12 | 0.385 |
| Pirarubicin | D4 | 0.17 | 0.045 | 0.075 |
| Plicamycin | D3 | 0.27 | 0.055 | 0.135 |
| Prednisolone | D3 | 0.1 | 0.055 | 0.055 |
| Prednisone | D3 | 0.1 | 0.055 | 0.055 |
| Progesterone | D3 | 0 | 0 | 0 |
| Raloxifene | D1 | 0 | 0 | 0 |
| Tamoxifen | D1 | 0 | 0 | 0 |
| Testosterone | D3 | 0.095 | 0.02 | 0.025 |
| Tetradecanoylphorbol Acetate | D4′ | 0.235 | 0.155 | 0.155 |
| Thiotepa | D1 | 0.31 | 0.15 | 0.56 |
| Trastuzumab Emtansine | D1 | 0.305 | 0 | 0 |
| Trilostane | D3 | 0 | 0 | 0 |
| Vandetanib | D3 | 0.26 | 0 | 0.045 |
| Velcade | D4′ | 0.68 | 0.58 | 0.51 |
| Vinblastine | D1 | 0.265 | 0.1 | 0.22 |
| Vinflunine | D2 | 0.255 | 0.055 | 0.14 |
| Avastin | D2′ | 0.21 | 0.07 | 0.085 |
| Ethyl Carbamate | D2′ | 0 | 0 | 0 |
| Imetelstat | D2′ | 0.26 | 0 | 0.09 |

Among these 68 drugs, 63 drugs reach more than 20 effectors via the pathway model. The other 5 drugs: Capecitabine, Gemcitabine, Marimastat, Pemetrexed and Rebimastat can only reach 2 effectors and are removed from calculation.

Map Drugs onto the Pathway

Drugs, including Donepezil, were mapped onto the pathway based on drug target information. To determine how drugs affect downstream proteins, directionality from HD was used. Furthermore, drugs were also checked on DrugBank to find target and directionality information. In addition, we also manually curated PubMed abstracts for each drug-protein pair from C2MAPS. There were 500 drug-protein relations examined for Breast Cancer. Each drug-protein relation was then classified into five primary categories: “up-regulation”, “down-regulation”, “indirect regulation”, “ambiguous regulation” and “unknown.” Table 2 shows all drug-protein relation and the associated encoding used in PETS. Our final product yielded an integrated breast cancer pathway with its associated drugs.

### Design the PETS (Pharmacology-Effect-on-Targets Simulator) Algorithm

We applied the ‘transmission’ concept in the PETS algorithm, where the drug's triggering signal transmits between nodes in the network. Here, we modeled the updating mechanism and transmission distribution similarly to PageRank, which has been previously applied and modified in molecular-network-based solutions for diseases biomarker identification. Since regulations in bio-molecular networks include both activation and inhibition, the signal was modeled as either positive or negative values, accordingly. The final drug-disease score, or PETS score, was measured by summarizing the overall effect of the drug to the pathway. The hypothesis is that a therapeutic drug's molecular signature should reverse molecular expressions from the disease condition to a normal condition on the pathway level.

### Annotation

z: a specific disease or a disease subtype.

M: pathway model. M_{z}: the specific pathway model for disease z. When there is only one disease mentioned or the disease is given, we use M to simplify the annotation.

p: molecule.

M_{z}(pᵢ, pⱼ): the regulation from molecule i to molecule j in the pathway model of disease z. When there is no ambiguity about the given disease, we use M(i, j) to simplify the annotation

Rp_{z}(pᵢ): significance of molecule i in disease z's pathway model. Similar to the previous annotation, we use Rp(i) to annotate the same content at a given disease.

ZP_{z}(pᵢ): the disease expression of molecule i (from the pathway model) at disease z condition. When there is no disease ambiguity, we use the simplified annotation ZP(i).

ZP_{z}: a vector showing all expression of all molecular in disease z's pathway model. The simplified annotation is ZP.

D: drug

PD(D, pᵢ): HD's score for the indication from drug d to molecule i. We use PD(i) for the same context when there is no ambiguity about the drug.

S_{z}(D, pᵢ): predicted drug molecule score using disease z's pathway model, drug D and molecule i. If there is no ambiguity about the disease, we use the simpler annotation S(D, pᵢ). If there is no ambiguity about both the drug and the disease, we use the simplest annotation S(i) for the same context.

From the iterative nature of the PETS algorithm, given both the disease and the drug, we annotate S(i, k) as the predicted drug molecule score at the k^{th} iteration. S(i) is the final predicted drug molecule score after the iterative process terminates.

PETS(D, z): the pharmacological effect on target score. The simplified annotations are PETS(D) given the disease, and PETS given both the drug and the disease.

PETS's Assumption about the Disease Pathway Model

PETS simulates the regulation chain between molecules in the disease pathway model as the transmission of signal in a network. In the signal network, each molecule becomes a node (or station), and each regulation becomes an edge (or channel). Each station stores some signal power, either positive (higher than normal condition), zero (normal condition) or negative (lower than normal condition). Each channel is either an activating channel (positive) or inhibiting channel (negative). Each station can receive signal from other station(s) and send out signals toward its downstream station(s). In the signal network, the drug triggers the initial signals to the drug's target(s), and this triggering signal remains intact over time.

PETS assumes the following rules about signal transmission:
The signal of a station at a given iteration only depends on the signal of its upstream station(s) at the previous iteration and the upstream channel.
The signal at every station converges.

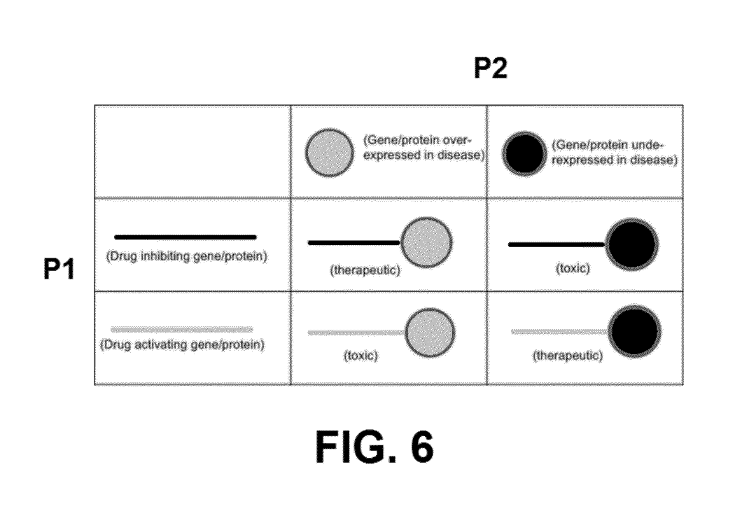

FIG. 6 demonstrates four possible cases of a downstream station, P2, receiving signal from an upstream station, P1, the channel of signal effect from drug to protein. In case a, when the signal at P1 is positive and the channel is activating, the signal at P2 is expected to be increasing, or positive. In case b, when the signal at P1 is negative and the channel is activating, the signal at P2 is expected to be decreasing, or negative. In case c, when the signal at P1 is positive and the channel is negative, the signal at P2 is expected to be decreasing, or negative. And in case d, when the signal at P1 is negative and the channel is negative, the signal at P2 is expected to be increasing, or positive. FIG. 3A shows an additional version of a chart showing a comparison using a HD dataset and using CMAP dataset on ranking consistency.

### Mathematical Framework to Simulate Signal Transmission

To simulate the signal transmission in PETS, we employed the novel iterative updating formula from PageRank:

$$S ( j , k ) = ( 1 - d ) {c}_{j} + d {\sum }_{i}^{N} \frac{M ( i , j ) \times S ( i , k - 1 )}{out\_deg ( i )}$$

Here, N is the total number of nodes in the network; k denotes the k^{th} iteration, i and j denote different nodes; out_deg(i) is the out-degree. In other words, the number of downstream connectors from i; cⱼ is the initial value of S(j). Damping factor d controls how much the new signal S(j, k) is updated from other nodes in the network. Hence, setting d=0 means that there is no update at j, implying that PETS is not applied, which leads to the PETS(−) framework. Setting d=1 implies that we totally update j value from the network. The first term in (4) refers to a constant factor applied to node j's value at every time j is updated, which reflects the PETS' assumption about the constant drug's triggering signal(s) to the drug's target(s). The triggering signal of molecule j (cⱼ) is 0 if j is not a drug's target and is nonzero otherwise. The second term in (4) implements PageRank's uniform delivery value idea, in which a node sends the node's value uniformly to all downstream node(s). PETS adopts this idea if all regulations in M are uniformly weighted. Otherwise, we replaced the denominator out_deg(i) by Σ_{∀j}M(i, j). The product M(i, j)×S(i, k−1) matches with the expectation in FIG. 3A. Different from PageRank in which M(i, j) is always non-negative, M(i, j) in PETS could be negative if the regulation from molecule i to molecule j is an inhibition reaction.

To meet more biological assumptions, we introduced several modifications in (4). First, since each biological interaction has a boosting factor, we add a factor b standing for boosting factor into the second term of (4). b receives a constant value for default, but it could be regulation-dependent based on some domain knowledge. For constant b, we design b>1 favoring the indication of the longer chain of regulation and vice versa. Second, due to the design of b, we introduced the notion of layer to decide when b is applied. From the network breadth-first search point of view, the k^{th} layer occurs only nodes visited at the k^{th} iteration. Thus, when updating signal S(j) by M(i, j)×S(i, k−1) at k^{th} iteration (currentLayer), b is applied if and only if station i is visited at the k−1^{th} iteration (previousLayer). Overall, we adjusted PageRank's updating mechanism into

$$S ( j , k ) = ( 1 - d ) {c}_{j} + [ \begin{matrix}d {\sum }_{i}^{N} \frac{b \times M ( i , j ) \times S ( i , k - 1 )}{out\_deg ( i )} & if j belongs to the previousLayer \\ d {\sum }_{i}^{N} \frac{M ( i , j ) \times S ( i , k - 1 )}{out\_deg ( i )} & if j does not belong to the previousLayer\end{matrix}$$

### Rp Score Adjustment

Estimating missing Rp scores is necessary before applying PETS algorithm since we included proteins outside C2MAP database in the pathway model. Let i be the protein in the pathway with the minimum C2MAP Rp score, and deg(i) be the degree of protein i in the pathway. For any protein j without Rp score, we estimate Rp(j) as following:

$$Rp ( j ) = Rp ( i ) \frac{deg ( j )}{deg ( i )}$$

After estimating missing Rp score, we selected the top 5% proteins having the highest Rp score and set the Rp score of these proteins to the 95% largest Rp score.

### PETS Pseudo Code and Pseudo Code Explanation

Based on the aforementioned assumptions, we designed PETS as follows to complete at least the following tasks:
Predicting the drug-molecular indication based on known drug-target indications and disease pathway models. From this task, we were able to suggest more drug-molecular indications which were not covered by HD or any other databases.
Compute the drug therapeutic score based on the predicted drug-molecular indications and ZP score. We complete this task by applying Lamb et al. novel statement: a therapeutic drug should reverse the molecular expression in the disease condition.

### Initialization

Given the drug-target of drug D and disease z's pathway model M, we trigger the signal at a molecule based on the molecule's degree and the drug's direct effector information:

S(i, 1)=max(out_deg(i), 1)×D(i)if pᵢ is the designed target of the drug

S(i, 1)=0.1×max(out_deg(i), 1)×D(i)if pᵢ is not the designed target of the drug (off-target)

Where D(i)=0 if pᵢ is not the direct effector of the drug. D(i)=1 if pᵢ is the direct effector of the drug and receives an activation signal from the drug. D(i)=−1 if pᵢ is the direct effector of the drug and receives an inhibition signal from the drug. This initialization assumes that the drug sends stronger signals towards its designed targets. We set the trigger signal as max(out_deg(i), 1) to ensure that the target still receives some signal even if the target does not have any downstream connection.

### Updating the s Array for Drug-Effector Prediction

For all molecules i that are not in the currentLayer, their signals are maintained: S(i, k)=S(i, k−1), Otherwise, we update the signal for all proteins i in currentLayer based on (5). In theory, step 2 is completed at the time step k_{con} when the signal power of every node converges. We chose the stopping condition as the inequality

$$\vert \frac{S ( i , k ) - S ( i , k - 1 )}{S ( i , k - 1 )} \vert < {10}^{- 5}$$

holds for all molecular i. In practice, for the breast cancer pathway model, it is completed when k_{con}=150, and may be different with different models. At the convergent point, we check the sequence s(i, 1→k_{con}) is converging to 0 by examining the ratio

$$\frac{\vert s ( i , {k}_{con} ) \vert}{{max}_{k} ( \vert s ( i , k ) \vert )} .$$

If the ratio is less than 0.05, the sequence s(i, 1→k_{con}) is considered converging to 0.

PETS completes task 1 by calculating s(i, k_{con}) as the final effect the molecule receives. If s(i, k_{con})>0, the effect is predicted as activation; if s(i, k_{con})<0, the effect was predicted as inhibition. Otherwise, the effect is unknown and not considered in evaluation. The score s(i, k_{con}) shows the algorithm's prediction of the drug-molecular indication associated with pᵢ.

### PETS Score Evaluation

The drug is scored using a weight-averaging technique, extending Lamb et al's idea, based on the following formula:

$$PETS \text{-} score = {\sum }_{ZP ( i ) \neq 0} \frac{- Rp ( i ) \times ZP ( i ) \times sign ( S ( i , {k}_{con} ) )}{Rp ( i )}$$

Drug having high PETS score is predicted as therapeutic, and vice versa.

### Develop Evaluation Metrics to Assess the Performance of the PETS Algorithms and Pathway Quality

### Task 1: Qualifying Pathway Model Using PETS Predicted Drug-Molecular Indication

We examine the quality of the pathway model by PETS's prediction about drug-molecule interactions in two criteria: quality and coverage. For quality, we measured the accuracy between PETS predicted indications with results queried from CET molecules (see the pathway development section) and HD. Let S(D, pᵢ) be the set of prediction and PD(D, pᵢ) is the set of queried result. We scored the quality of PETS's drug-molecular prediction by the following accuracy score:

$$\frac{\vert S ( D , {p}_{i} ) = PD ( D , {p}_{i} ) \vert}{\vert ( S ( D , {p}_{i} ) \neq 0 ) ⋂ ( PD ( D , {p}_{i} ) \neq null ) \vert}$$

The numerator is the number of cases when PETS's prediction matches with HD data, while the denominator is the intersection between cases in which PETS can predict and HD has the corresponding drug-molecular indication. For coverage, we computed the ratio of observed indications which could be retrieved by PETS and the pathway model

$$\frac{\vert ( S ( D , {p}_{i} ) \neq 0 ) ⋂ ( PD ( D , {p}_{i} ) \neq null ) \vert}{\vert ( PD ( D , {p}_{i} ) \neq null ) \vert}$$

In the breast cancer pathway model, the acceptant threshold for both quality and coverage is 0.7.

### Task 2: the Quality of PETS in Scoring the Drug Therapy

To evaluate the quality of PETS in scoring the therapeutic properties of drugs, we observed whether or not the PETS score for drugs represent the drug categories defined by clinical trial evidence. Given a disease, we divide the tested drugs into 4 different categories. The first set, denoted by D1, consists of drugs approved by FDA to treat the disease. The second set, denoted by D2, includes drugs designed for the disease and currently in trial. The third set, denoted by D3, contains drugs approved by FDA but for treating some other disease. In addition, information about clinical trials using D3 drugs for the given disease is not found. The last set, denoted by D4 (in this example), or red set, includes drug not approved by FDA for any treatment. In D4, we denote the subset of drugs which was discontinued/removed from market as D4′. The withdrawn disease-specific drugs as is denoted by D2′ and serves as negative-control drug during PETS development and parameter turning. Overall, we expect PETS scores for drugs in the green set stand at the most positive region, following by scores of drugs in the blue set, then by scores of drugs in the yellow set, and scores for drugs in the red set stand in the most negative region.

However, we paid more consideration on drugs in yellow set and red set having positive PETS score, since these drugs could be candidate for drug repurposing. For these drugs, we attempted to find literature evidence supporting PETS's prediction. As observed in the result section, PETS is able to give creditable drugs for repurposing in the Breast Cancer case study.

### Examining PETS Robustness

To examine PETS robustness against pathway noise, we developed four different types of pathway perturbations to apply PETS on: randomly adding regulations (adding edges), randomly deleting regulations (deleting edges), randomly changing regulations sign (from activation to inhibition and vice versa, or changing edges) and randomly redirecting regulations (redirecting edges). Each experiment of perturbation had 200 randomly-generated pathways. We defined a g-parameter to control the perturbation.

### Generating Noisy Network by Adding Interactions

First, a parameter g (0<g<

$$\frac{{N}^{2} - N - \vert E \vert}{\vert E \vert} ,$$

where N is the number of pathway's molecular, |E| is the number of regulations in the original pathway, and N²−N−|E| is the maximum number of regulations which could be added) was chosen to determine the number of added regulations to generate. Then, we randomly selected g|E| pairs of molecular (with considering directionality) in the network where new regulations could be added such that each set of new g|E| regulations could be selected uniformly. Then, at each pair, the new regulations received either activation or inhibition with equal probability.

### Generating Noisy Networks by Removing, Changing Interaction Signature and Redirecting Interactions

A parameter g (0<g<1) was chosen as the probability that we change the information of an original interaction. After that, for each interaction in the original network, we uniformly generated a random number q between 0 and 1. If q<g, either the interaction was removed, its signature was flipped between activation and inhibition, or the interaction was redirected. Choosing g=0.5 results the most chaotic network. When testing PETS score robustness, we assumed that the pathway model is highly qualified, and set g=0.05. Meanwhile, to test PETS's drug-molecular prediction, we assumed that the pathway was completely random and set g=0.5. More details about the impact of pathway noise are discussed in supplemental material.

### Significant Test of PETS Score

To examine the significant of PETS score, we perturbed the PETS score computation in (6) by the randomly permutate the predicted drug-molecular score (denoted by ZP) 400 times for each drug. Since we did not know the underlying distribution of PETS score in some cases, we applied the framework in to empirically estimate the PETS score p-value if the underlying distribution of PETS score is not normal. According to at least one resource, the smallest possible empirical p-value is (r+1)/(N+1)=1/401=0.00249. We also calculate the p-value of the student t-test. If the t-test p-value is less than 0.00249, we select 0.00249 as the adjusted p-value. If not, we select the minimum between empirical p-value and t-test p-value as the adjusted p-value.

### Parameters and Model Optimization of the PETS Program to the Study of Disease-Specific Pathway Models

### Optimizing Parameters

We selected the boosting factor b and damping factor d for each disease pathway model by scanning the range of b options from 1 to 2, with increments of 0.05, and the range of d option from 0 to 1, with increments of 0.05. The combination of b and d is the one achieving the highest accuracy mentioned in section 9.a.

### Pathway Model Optimization

From the curated pathway satisfying the quality and quantity measurement in (7) and (8), we attempted to add more regulations into the pathway to increase the quantity measurement in (8). To add one regulation in a pathway, first, we randomly selected a pair of molecular without curated regulation. Second, we randomly added the directionality and signature of the regulation. Third, we ran PETS drug-molecular prediction. If the quality measured by (8) increased at least by 0.006, we accepted the new regulation. Otherwise, we discarded the regulation and go back to the first step to try another regulation. After adding 9 regulations, we decided to stop optimization since the runtime to add the 10^{th} regulation takes much longer than expected.

### PETS Development

### Pathway Topological Problem in PETS Development

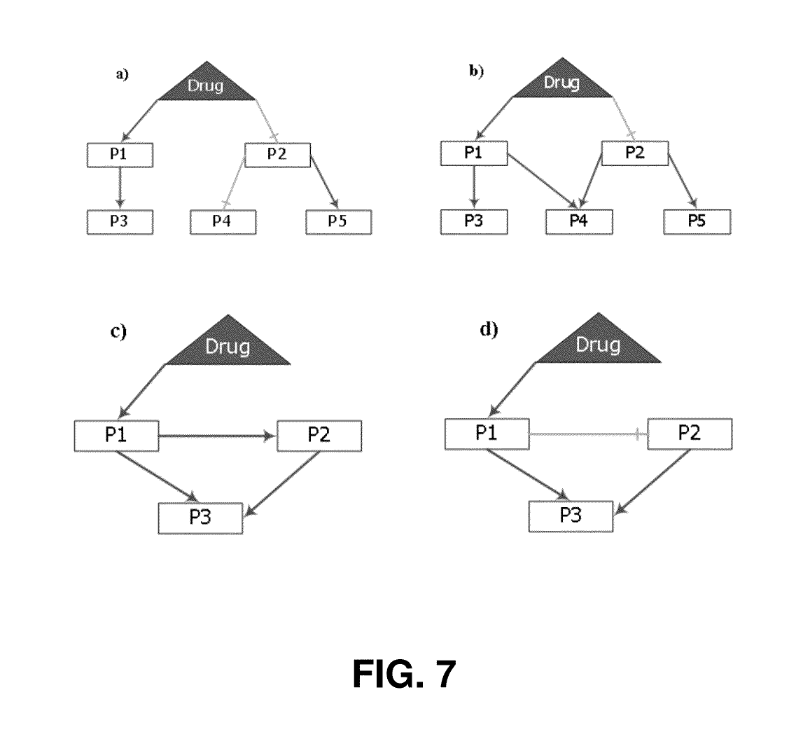

In this study, we divide the PETS network into 4 basic categories based on topology:
The linear tree structure. The drug is the root of the tree and for each protein, there is only one path to reach the protein from the drug. This is the simplest topological structure in which the four multiplication rules can be easily applied. In addition, convergence is solved since the signal only transmits inside the network for a finite number of times. Subsection a of FIG. 7 represents a simple linear tree structure or network.
The acyclic competitive structure. There exist some proteins reachable from the drug by more than one path; in addition, the different path contains opposite effects. Networks belonging to this category do not contain any cycles. Therefore, convergence is solved. The challenge for this topological structure is balancing different effects received from different paths. Subsection b of FIG. 7 illustrates an acyclic competitive structure: the path (Drug-P1-P4) demonstrates an activation effect on P4 while the path (Drug-P2-P4) demonstrates an inhibition effect. The result in this case depends on the choice of boosting factor b.
The cyclic non-oscillation structure: there exist some cycle in the network, and the number of inhibition edges travelling along the cycle is even. Therefore, the effect on a protein on the cycle at each revisiting time does not change. The major challenge in this structure is convergence. Subsection c of FIG. 7 demonstrates an example of this structure, noting that after each travelling round, the overall effect of all P1, P2, and P3 is activation.
The cyclic oscillation structure: there exist some cycle in the network, and the number of inhibition edges travelling along the cycle is odd. Thus, the effects at a node at two consecutive revisiting times are opposite. Similar to the cyclic non-oscillation structure, the major challenge in this structure is convergence. Subsection d of FIG. 7 shows an example of this structure, noting that after the first round, the effect at P2 is inhibition (one ‘−’) while after the second round, the effect at P2 is activation (two ‘−'s).

We define the following annotations when examining PETS's behavior in some synthetic pathways:
The definition of “−” refers to the direction of expression of the protein under constant drug perturbations goes lower than its original disease state; or the protein's functionality is lower than its default condition.
The definition of “+” refers to the direction of expression of the protein under constant drug perturbations goes higher than its original disease state; or the protein's functionality is higher than its default condition.
++: the protein's expression/functionality converges to a high positive number.
−−: the protein's expression/functionality converges to a high negative number.

### Impact of Pathway Noise on PETS's Result

In this section, we examine the impact of pathway noise on PETS's drug-molecular prediction, since the result of this task is then employed in computing PETS score. As described in the method section, given the disease z, then the score S(D, pᵢ) is the predicted drug-molecular indication. Given |D| drugs and |p| molecular in the pathway model, we setup matrix S of size |p|×|D| storing all drug-molecular prediction. With a noisy pathway, we computed prediction matrix S′ storing the same information. For measuring the impact of noisy pathway on drug-molecular prediction, we compute the average first-norm difference between S and S′ by the following formula:

$$\frac{{\sum }_{∀ D , p} \vert S ( D , {p}_{i} ) - {S}^{′} ( D , {p}_{i} ) \vert}{\vert D \vert \times \vert p \vert}$$

The average first-norm difference receives 0 if S and S′ are perfectly matched, and receives the highest value 2 if all entries in S and S′ are nonzero and the corresponding entries in S and S′ are opposite.

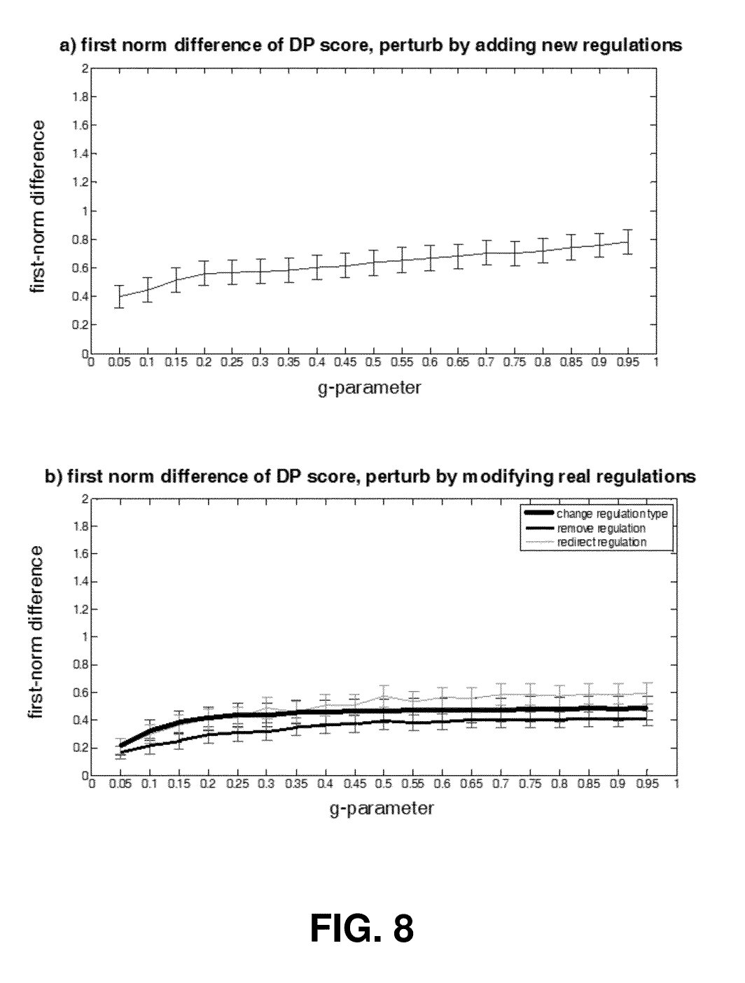

In FIG. 8, we show the mean of first-norm difference in each experiment corresponding to each g-parameter—which decides the level pathway noise—in Breast Cancer pathway with 63 drugs mentioned in the main text result section. Since the setup for the last three types of perturbation are similar, we present theirs results in one graph. In all noise setups, we observe that the average first-norm difference between S and S′ increases. The noise caused by removing regulation has the least impact on Breast Cancer drug-protein prediction, and the noise caused by redirecting regulations has the most impact on the prediction.

### Constraint Parameter

In this section, we apply linear algebra to analyze some properties of PETS simulation and prove that PETS will converge given any pathway when its two parameters satisfy some constrains.

We can represent (5) in vector-matrix form as

\vec{s}ₖ=(1−d)\vec{c}+bdAₖ\vec{s}ₖ₋₁(7)

in which \vec{s}ₖ is the collection of signals at every nodes at kth iteration and matrix Ak represents all transitions at kth iteration. If the pathway does not have any cycles, when k reaches the longest pathlength in the pathway, PETS will terminate and trivially converge. If the pathway has some cycle(s), apply (7) recursively after L iteration, in which L is the longest cycle length in the pathway. Then

$$\begin{matrix}\vec{{s}_{k}} = ( 1 - d ) \vec{c} + b {dA}_{k} \vec{{s}_{k - 1}} \\ = ( 1 - d ) \vec{c} + {bdA}_{k} ( ( 1 - d ) \vec{c} + {bdA}_{k - 1} \vec{{s}_{k - 2}} ) \\ = ( I + {bdA}_{k} ) ( 1 - d ) \vec{c} + {b}^{2} {d}^{2} {A}_{k} {A}_{k - 1} \vec{{s}_{k - 2}} \\ = … \\ = ( 1 - d ) \vec{c} {\sum }_{i = 0}^{L} {b}_{i} {d}_{i} {A}_{i} + {b}^{L} {d}^{L} {A}_{k} {A}_{k - 1} … {A}_{k - L} \vec{{s}_{k - L}}\end{matrix}$$

Which has the form

\vec{sₖ*}=\vec{c*}+b*d*A*\vec{sₖ₋₁*}

in which

$$\vec{{c}^{*}} = ( 1 - d ) \vec{c} {\sum }_{i = 0}^{L} {b}_{i} {d}_{i} {A}_{i} ,$$

b*=bL, d*=dL and A*=AₖAₖ₋₁ . . . A_{k-L} Then

$$\begin{matrix}\vec{{s}_{{k}^{*}}} = \vec{{c}^{*}} + {b}^{*} {d}^{*} {A}^{*} \vec{{s}_{{k}^{*} - 1}} \\ = \vec{{c}^{*}} + {b}^{*} {d}^{*} {A}^{*} [ \vec{{c}^{*}} + {b}^{*} {d}^{*} {A}^{*} \vec{{s}_{{k}^{*} - 2}} ] \\ = ( I + {b}^{*} {d}^{*} {A}^{*} ) \vec{{c}^{*}} + ( 1 - d ) {( {b}^{*} {d}^{*} {A}^{*} )}^{2} \vec{{s}_{{k}^{*} - 2}} \\ = … \\ = {\sum }_{l = 0}^{{k}^{*} - 1} {( {b}^{*} {d}^{*} {A}^{*} )}^{l} {c}^{*} + {( {bdA}^{*} )}^{{k}^{*}} \vec{{s}_{1}} .\end{matrix}$$

### Then,

$$\vec{{s}_{∞}} = {\sum }_{l = 0}^{∞} {( {b}^{*} {d}^{*} {A}^{*} )}^{∞} \vec{{c}^{*}} + {( {b}^{*} {d}^{*} {A}^{*} )}^{∞} \vec{{s}_{1}} .$$

Let |λ|ₘₐₓ be the largest absolute value of b*d*A*. Use SVD decomposition, we see that \vec{s_{∞}} is convergent if and only if b*d*|λ|ₘₐₓ<1. To find the bound, we find L, then compute A* and the largest eigenvalue of A*. This bound is very flexible to satisfy. A safe option is choosing b and d such that bd<1.

### Apply PETS in Breast Cancer Case Study

The distribution of Breast Cancer drugs into 5 categories is as follows. D1 category includes 18 drugs. D2 category includes 12 drugs. D3 category has 25 drugs approved by the FDA for some other disease(s) instead of breast cancer. D4 category contains 6 drugs. The last category, denoted by D2′, contains 7 drugs. In addition, we create the null drug set, denoted by D5, which consists of drugs generated by randomly targeting non-CET molecules in the Breast Cancer pathway model. The number of random targets is chosen uniformly between 1 and 15.

Besides the Breast Cancer pathway model and Breast Cancer related drug-protein interactions from HD, PETS requires the disease expression context as an input. For this purpose, we selected dataset GSE10886 from Gene Expression Omnibus (GEO) database. GSE10886 is among the largest and most comprehensive Breast Cancer microarray in GEO. After the latest update in January 2013, GSE10886 has 226 samples and includes samples from both ER+ and ER− subtypes. This dataset has been well studied and the design of the dataset allows application of PETS in disease specific and disease subtype context.

Design Alternative Frameworks from HD-Pathway-PETS by Removing One among Three Components

The designs for alternative framework to HD-pathway-PETS are as follow. First, to examine the role of HD, we designed framework HD(−) by removing HD data from PETS input and replace HD data by Broad Institute CMAP data for drug-protein perturbation effects. Second, to remove pathway component from HD-PETS, we designed framework PA(−) by employing a null pathway model instead of the curated pathway model. To generate the null pathway model, we directly connected drugs' target molecule to C and E molecules if the connection is available in some independent database. In the Breast Cancer case study, the database we employed was STRING version 9.1. Third, to remove PETS, we skipped the updating mechanism in PETS design and computed the drug's PETS score using (6) and HD instead of S(i, k_{con}) factor. A positive PETS score indicates a drug has a strong chance of therapeutic success with a higher score meaning a higher chance.

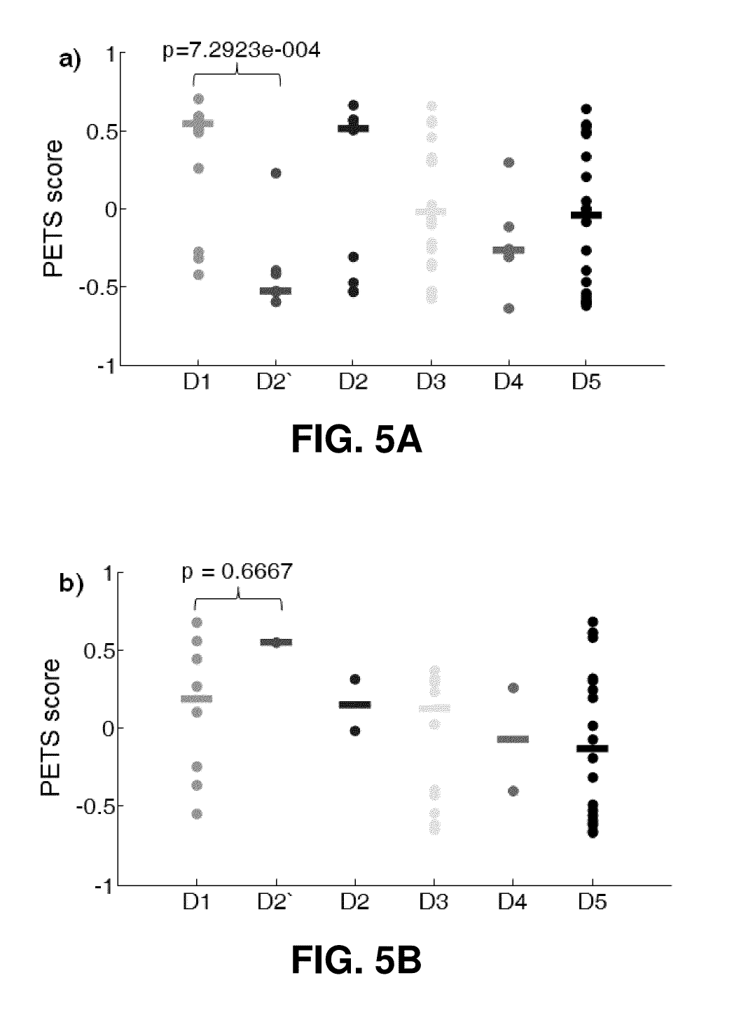

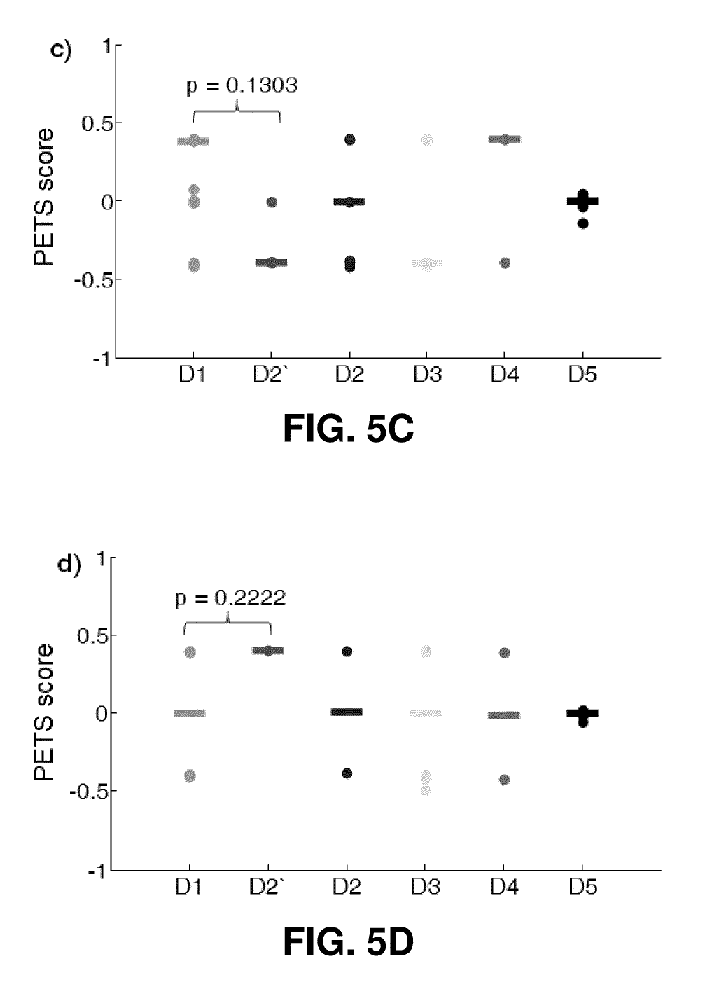

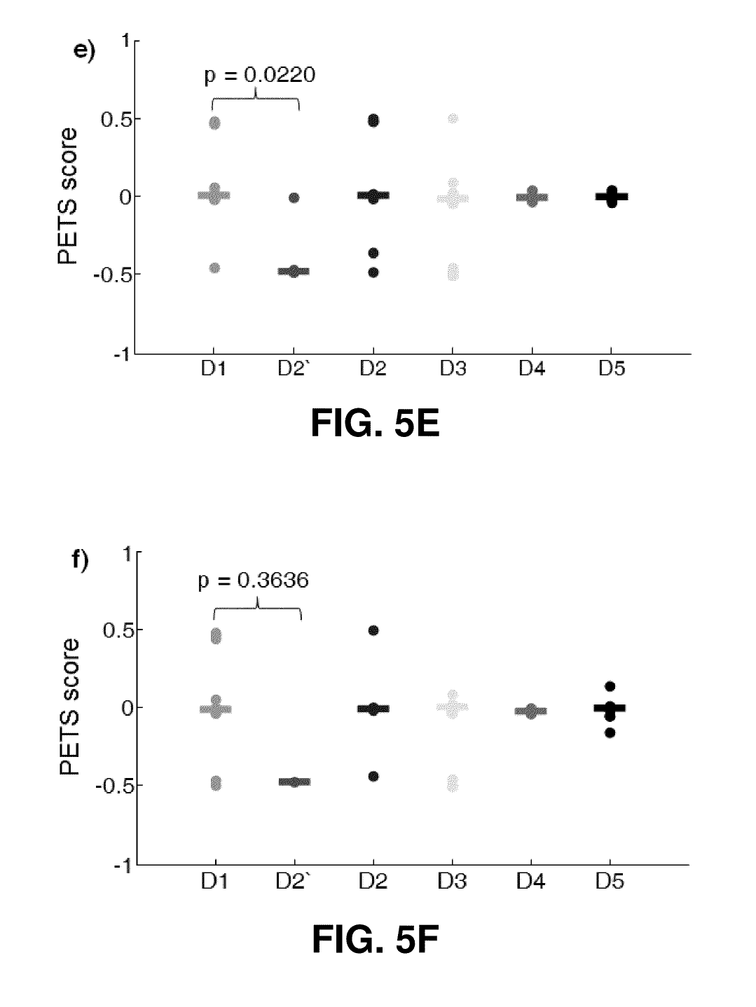

FIGS. 5A-5F depict PETS data in connection with various drugs/compounds within categories D1, D2, D2′, D3, D4, and D5. FIG. 5A (having an “a)” in the upper left corner) shows PETS scores for each of categories D1, D2, D2′, D3, D4, and D5, using HD (drug-protein “high-definition”, i.e., well-validated data sets from curation). FIG. 5B (having a “b)” in the upper left corner) shows PETS scores for each of categories D1, D2, D2′, D3, D4, and D5, using CMAP (Broad Institute's drug-gene connectivity map data, which can have spotty coverage and biased toward cell lines). FIG. 5C (having a “c)” in the upper left corner) shows PETS scores for each of categories D1, D2, D2′, D3, D4, and D5, using HD without performing pathway modeling. FIG. 5D (having a “d)” in the upper left corner) shows PETS scores for each of categories D1, D2, D2′, D3, D4, and D5, using CMAP without performing pathway modeling. FIG. 5E (having an “e)” in the upper left corner) shows PETS scores for each of categories D1, D2, D2′, D3, D4, and D5, using HD without the use of PETS simulations. FIG. 5F (having an “f)” in the upper left corner) shows PETS scores for each of categories D1, D2, D2′, D3, D4, and D5, using CMAP without the use of PETS simulations.

While various embodiments of drug identification models and methods of using the same to identify compounds to treat disease have been described in considerable detail herein, the embodiments are merely offered as non-limiting examples. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A computer-implemented method, comprising the steps of:
selecting at least one first drug/compound which is not actively approved by a governmental regulatory entity to treat a targeted disease or condition, which was not previously approved to treat the targeted disease or condition, and which was not previously withdrawn from clinical testing in connection with the targeted disease or condition;
testing using a framework the at least one first drug/compound to obtain first drug/compound data, wherein the framework is configured based upon at least:
a) second drug/compound data from within the framework, the second drug/compound data obtained from at least one second drug/compound which is actively approved to treat a targeted disease or condition,
b) third drug/compound data from within the framework, the third drug/compound data obtained from at least one third drug/compound which selected from the group consisting of a drug/compound previously approved to treat the targeted disease or condition and a drug/compound previously withdrawn from clinical testing in connection with the targeted disease or condition, and
c) integrated drug-to-target information, drug-to-gene information, and protein-to-protein information each relevant to the targeted disease or condition;
comparing the first drug/compound data to the second drug/compound data and the third drug/compound data to determine if the first drug/compound data and/or the third drug/compound data identifies a candidate drug/compound to treat the targeted disease or condition.

2. The method of claim 1, wherein the step of comparing comprises the step of ranking the first drug/compound data, the second drug/compound data, and the third drug/compound data in an order from most positive to least positive, wherein the most positive is indicative of a drug/compound likely to be the most effective to treat the targeted disease or condition.

3. The method of claim 1, wherein the step of testing comprises testing using the framework comprising a drug-molecular indication database.

4. The method of claim 1, wherein the at least one first drug/compound comprises at least one drug/compound under clinical testing to treat the targeted disease or condition.

5. The method of claim 1, wherein the at least one first drug/compound comprises at least one drug/compound under pre-clinical testing to treat the targeted disease or condition.

6. The method of claim 1, wherein the at least one first drug/compound comprises at least one drug/compound previously approved to treat a disease or condition that is not the targeted disease or condition.

7. The method of claim 1, wherein the at least one first drug/compound comprises at least one drug/compound withdrawn from clinical testing in connection with a targeted disease or condition that is not the targeted disease or condition.

8. The method of claim 1, wherein the at least one third drug/compound is not approved to treat the targeted disease or condition for safety or efficacy reasons.

9. The method of claim 1, wherein the framework comprises a processor operably coupled to a storage medium, the storage medium having software stored therein configured for use by the processor to perform the testing step and the comparing step.

10. The method of claim 1, further comprising the step of:
administering a dose of one of the at least one candidate drug/compound to a patient having the targeted disease or condition to treat the patient.

11. The method of claim 1, wherein at least one of the at least one first drug/compound has at least one chemical structure similar to at least one of the at least one second drug/compound.

12. The method of claim 1, wherein at least one of the at least one first drug/compound and at least one of the at least one second drug/compound targeted a common disease risk gene.

13. The method of claim 2, wherein the step of ranking is performed to rank based upon inferred mechanisms of action.

14. The method of claim 2, wherein the step of ranking is performed to rank based upon subsequent cell line or patient-derived samples.

15. The method of claim 1, wherein the at least one first drug/compound comprises donepezil, donepezil hydrochloride, or a variant thereof, wherein the targeted disease or condition comprises breast cancer, and wherein the first drug/compound data identifies that at least one of donepezil, donepezil hydrochloride, or a variant thereof, as the candidate drug/compound to treat breast cancer.

16. The method of claim 15, further comprising the step of:
administering a dose of the at least one of donepezil, donepezil hydrochloride, or a variant thereof, to a patient having breast cancer to treat the patient.

17. The method of claim 1, wherein at least one candidate drug/compound to treat the targeted disease or condition is identified from performing the comparing step.

18. A framework comprising a computer system having a processor operably coupled to a storage medium, whereby the storage medium has software stored thereon configured to be used by the processor to perform a computer implemented method, the computer-implemented method comprising the steps of:
selecting at least one first drug/compound which is not actively approved by a governmental regulatory entity to treat a targeted disease or condition, which was not previously approved to treat the targeted disease or condition, and which was not previously withdrawn from clinical testing in connection with the targeted disease or condition;
testing using a framework the at least one first drug/compound to obtain first drug/compound data, wherein the framework is configured based upon at least:
a) second drug/compound data from within the framework, the second drug/compound data obtained from at least one second drug/compound which is actively approved to treat a targeted disease or condition,
b) third drug/compound data from within the framework, the third drug/compound data obtained from at least one third drug/compound which selected from the group consisting of a drug/compound previously approved to treat the targeted disease or condition and a drug/compound previously withdrawn from clinical testing in connection with the targeted disease or condition, and
c) integrated drug-to-target information, drug-to-gene information, and protein-to-protein information each relevant to the targeted disease or condition;
comparing the first drug/compound data to the second drug/compound data and the third drug/compound data to determine if the first drug/compound data and/or the third drug/compound data identifies a candidate drug/compound to treat the targeted disease or condition.

19. The framework of claim 18, wherein the step of comparing comprises the step of ranking the first drug/compound data, the second drug/compound data, and the third drug/compound data in an order from most positive to least positive, wherein the most positive is indicative of a drug/compound likely to be the most effective to treat the targeted disease or condition.

20. A computer-implemented method, comprising the steps of:
selecting at least one first drug/compound which is not actively approved by a governmental regulatory entity to treat a targeted disease or condition, which was not previously approved to treat the targeted disease or condition, and which was not previously withdrawn from clinical testing in connection with the targeted disease or condition;
testing using a framework the at least one first drug/compound to obtain first drug/compound data, wherein the framework is configured based upon at least:
a) second drug/compound data from within the framework, the second drug/compound data obtained from at least one second drug/compound which is actively approved to treat a targeted disease or condition,
b) third drug/compound data from within the framework, the third drug/compound data obtained from at least one third drug/compound which selected from the group consisting of a drug/compound previously approved to treat the targeted disease or condition and a drug/compound previously withdrawn from clinical testing in connection with the targeted disease or condition, and
c) integrated drug-to-target information, drug-to-gene information, and protein-to-protein information each relevant to the targeted disease or condition;
comparing the first drug/compound data to the second drug/compound data and the third drug/compound data to determine if the first drug/compound data and/or the third drug/compound data identifies a candidate drug/compound to treat the targeted disease or condition and ranking the first drug/compound data, the second drug/compound data, and the third drug/compound data in an order from most positive to least positive, wherein the most positive is indicative of a drug/compound likely to be the most effective to treat the targeted disease or condition;
wherein at least one candidate drug/compound to treat the targeted disease or condition is identified from performing the comparing step.
